(19) United States
(12) Patent Application Publication
(10) Pub. No.: US 2014/0019101 A1
(43) Pub. Date: Jan. 16, 2014

(54) METHOD OF SIMULATION AND DESIGN OF A SEMICONDUCTOR DEVICE

(71) Applicant: Crosslight Software Inc., Burnaby (CA)

(72) Inventor: Zhanming Li, Vancouver (CA)

(73) Assignee: Crosslight Software Inc., Burnaby (CA)

(21) Appl. No.: 14/025,902

(22) Filed: Sep. 13, 2013

Related U.S. Application Data
(62) Division of application No. 13/161,568, filed on Jun. 16, 2011.
(60) Provisional application No. 61/355,191, filed on Jun. 16, 2010.

(51) Int. Cl. G06F 17/50

(52) U.S. Cl. CPC G06F 17/5045
USPC 703/2

(57) ABSTRACT

The invention relates to a method of simulation of semiconductor devices, such as wide-bandgap devices. The method employs a device substitution technique and involves simulation of a device which is structurally similar to the target device, and for which it is relatively easy to compute a model. Such a device may have a reduced material bandgap or a different doping/fixed-charge concentration. Based on the model of the simplified device, a model of the device under consideration is produced via a sequence of simulation steps, wherein simulated intermediate devices eventually transform into the target device for which a model is sought.

### CROSS-REFERENCE TO RELATED APPLICATIONS

The present invention claims priority from U.S. Patent Application No. 61/355,191 filed Jun. 16, 2010, which is incorporated herein by reference for all purposes.

### TECHNICAL FIELD

The present invention relates to semiconductor devices and more specifically to methods of computer simulation of semiconductor devices.

### BACKGROUND OF THE INVENTION

Semiconductor devices have a wide variety of applications such as photovoltaics (solar cells), telecommunications (laser diodes), consumer products (high-brightness light-emitting diodes), and computers (transistors). The continued development of semiconductor devices drives many technological improvements in other fields.

The computer-based simulation of semiconductor devices is an important component in the design process. Simulation is used for prototyping and validation of new design ideas, and at least partially replaces wafer processing and testing, which are time consuming and have associated costs.

Computer simulation of the behavior and manufacturing of semiconductor devices and integrated circuits including semiconductor devices is taught e.g. in U.S. Pat. No. 6,651,226 in the name of Houge et al., U.S. Pat. No. 7,421,383 in the name of Hsiao et al., U.S. Pat. Nos. 7,024,645 in the name of Sumikawa, 6,883,153 in the name of Jiang et al., 7,792,595 in the name of Bomholt et al., 7,923,266 in the name of Thijs et al., 7,584,438 in the name of Moroz et al.

Software-based Technology Computer-Assisted Design (TCAD) tools help in the design of semiconductor devices because they can predict device performance and provide useful information which may not be possible or practical to measure directly, such as band diagrams, local distribution of temperature and carrier density (electron/hole) as well as the internal current flow.

Conventional TCAD tools for simulation of semiconductor devices are based on finite element/finite volume analysis and solve a set of equations grouped together under the designation of the “Drift-Diffusion” (or “DD”) model, which include the Poisson's equation:

$$- {∇}^{->} \cdot ( \frac{{ɛ}_{0} {ɛ}_{dc}}{q} {∇}^{->} V ) = p - n + {N}_{D} ( 1 - {f}_{D} ) {N}_{A} {f}_{A} + {\sum }_{J} {N}_{tj} ( {δ}_{j} - {f}_{tj} ) \qquad ( 1 )$$

and the current continuity equations for electrons and holes

$${∇}^{->} \cdot {{J}^{->}}_{n} - {\sum }_{J} {R}_{n}^{tj} - {R}_{sp} - {R}_{st} - {R}_{a u} + {G}_{opt} = \frac{\partial n}{\partial t} + {N}_{D} \frac{\partial {f}_{D}}{\partial t} \\ and \\ {∇}^{->} \cdot {{J}^{->}}_{p} + {\sum }_{J} {R}_{p}^{tj} + {R}_{sp} + {R}_{st} + {R}_{a u} - {G}_{opt} = - \frac{\partial p}{\partial t} + {N}_{A} \frac{\partial {f}_{A}}{\partial t} , \qquad ( 3 )$$

wherein ε₀-permittivity in vacuum, ε_{dc}—relative permittivity of material at zero frequency, q—magnitude of electronic charge, V—potential, n and p—density of free electrons/holes, N_{D}, N_{A}, Nₜⱼ are donor/acceptor/trap impurity concentrations, f_{D}, f_{A}, fₜⱼ are probabilities of occupation for donor/hole/trap states, δⱼ is used to switch between acceptor-type (−N*f) and donor-type (+N*(1−f)) trap behavior, Jₙ and Jₚ-net current flux for electrons/holes, R^{t}—trap recombination rate (Shockley-Read-Hall), Rₛₚ—spontaneous emission recombination rate, Rₛₜ—stimulated emission recombination rate, Rₐᵤ—Auger recombination rate, Gₚₚₜ—optical generation rate, t—time.

The electron and hole concentrations in bulk semiconductors are defined by Fermi-Dirac distributions and a parabolic density of states which, when integrated, yield

$$n = {N}_{c} {F}_{1 / 2} ( \frac{{E}_{fn} - {E}_{c}}{kT} ) , \\ p = {N}_{v} {F}_{1 / 2} ( \frac{{E}_{v} - {E}_{fp}}{kT} ) , \qquad ( 4 )$$

where F_{1/2} is the Fermi integral of order one-half, N_{c} and Nᵥ are density of electron and hole states, E_{fn} and E_{fp} are the electron and hole quasi-Fermi levels and E₁ and Eᵥ are the conduction and valence band edges. The energy separation of the band edges is defined as the bandgap (E_{g}) of the material:

E_{c}=Eᵥ+E_{g}. (5)

However, conventional methods do not work well for wide bandgap semiconductor devices in particular because the transmission probability by thermionic emission process at heterojunctions declines exponentially with the barrier height, which causes loss of precision and instability of numerical methods. Another issue is the intrinsic carrier density which is the population of electrons and holes in an undoped semiconductor at equilibrium. This value is roughly proportional to exp(−Eg/kT), where kT is the thermal energy of the carriers. Therefore, larger bandgaps and low temperatures are associated with lower intrinsic densities and very low electric current values, which creates the problem of enforcing the current continuity within the limits of fixed precision arithmetic on a computer.

An object of the present invention is to overcome the shortcomings of the prior art by providing a novel method of computer simulation of semiconductor devices.

### SUMMARY OF THE INVENTION

The present invention relates to a method of computer simulation of a wide-bandgap semiconductor device with a bandgap parameter having a wide-bandgap value, including:

(a) providing a model of a narrow-bandgap device, wherein the model includes the bandgap parameter having a low-bandgap at least 10% less than the wide-bandgap value;

(b) increasing an electric current in the model of the narrow-bandgap device by gradually adding an external bias to the model of the narrow-bandgap device and computing a biased model of the narrow-bandgap device;

(c) modifying the biased model of the narrow-bandgap device so as to change a value of the bandgap parameter to the wide-bandgap value, by gradually increasing the value of the bandgap parameter and computing a biased wide-bandgap model; and,

(d) reducing the external bias in the biased wide-bandgap model so as to gradually change said biased wide-bandgap model by decreasing the external bias and computing a model of the wide-bandgap semiconductor device.

The external bias may be a voltage, reverse voltage, or light.

Another aspect of the present invention relates to a method of computer simulation of a semiconductor device, the semiconductor device described by device parameters having semiconductor-device values; the method including:

(a) providing a model of a first device, the model comprising the device parameters, wherein the device parameters comprise selected parameters and non-selected parameters, wherein the non-selected parameters of the first device have the semiconductor-device values and the selected parameters of the first device have first-device values different from the semiconductor-device values for the selected parameters, and wherein the model of the first device is a solution of a system of equations including the device parameters;

(b) simulating an increase of an electric current in the first device by adding an external bias to the model of the first device, comprising a first series of steps, wherein, at each step in the first series, a biased model is obtained by computerized solving the system of the equations with an external bias, wherein at a first step in the first series the computerized solving uses the model of the first device and at each next step in the first series the computerized solving uses the biased model obtained at a previous step in the first series, and wherein at each next step in the first series the external bias is greater than or equal to the external bias at a previous step in the first series;

(c) correcting the biased model obtained at a last step in the first series, comprising a second series of steps, at each step in the second series a corrected model is obtained by computerized solving the system of the equations with an external bias, wherein at a first step in the second series the computerized solving uses the biased model obtained at the last step in the first series and at each next step in the second series the computerized solving uses the corrected model obtained at a previous step in the second series, and wherein at each next step in the second series the external bias is less than or equal to the external bias at a previous step in the second series; wherein values of the selected parameters change along the second series of steps so as to reach the semiconductor-device values, and a last corrected model in the second series is a model of the semiconductor device; and,

(d) forming an output based on the model of the semiconductor device and outputting the output.

Yet another aspect of the invention provides a non-transitory computer-readable storage medium configured with software for computer simulation of a semiconductor device described by device parameters having semiconductor-device values, the software, when executed by a computer system, causing the computer system to

(a) simulate an increase of an electric current in the first device by adding an external bias to a model of the first device, wherein the model of the first device is a solution of a system of equations including the device parameters; wherein the device parameters comprise selected parameters and non-selected parameters, the non-selected parameters of the first device have the semiconductor-device values and the selected parameters of the first device have first-device values different from the semiconductor-device values for the selected parameters, wherein simulating the increase of the electric current comprises a first series of steps, wherein, at each step in the first series, a biased model is obtained by computerized solving the system of the equations with an external bias, wherein at a first step in the first series the computerized solving uses the model of the first device and at each next step in the first series the computerized solving uses the biased model obtained at a previous step in the first series, and wherein at each next step in the first series the external bias is greater than or equal to the external bias at a previous step in the first series;

(b) correct the biased model obtained at a last step in the first series, comprising a second series of steps, at each step in the second series a corrected model is obtained by computerized solving the system of the equations with an external bias, wherein at a first step in the second series the computerized solving uses the biased model obtained at the last step in the first series and at each next step in the second series the computerized solving uses the corrected model obtained at a previous step in the second series, and wherein at each next step in the second series the external bias is less than or equal to the external bias at a previous step in the second series; wherein values of the selected parameters change along the second series of steps so as to reach the semiconductor-device values, and a last corrected model in the second series is a model of the semiconductor device; and,

(c) provide an output based on the model of the semiconductor device.

Yet another aspect of the present invention relates to a method of designing a semiconductor device, the semiconductor device described by device parameters having semiconductor-device values; the method comprising:

(a) providing a model of a first device, the model comprising the device parameters, wherein the device parameters comprise selected parameters and non-selected parameters, wherein the non-selected parameters of the first device have the semiconductor-device values and the selected parameters of the first device have first-device values different from the semiconductor-device values for the selected parameters, and wherein the model of the first device is a solution of a system of equations including the device parameters;

(b) simulating an increase of an electric current in the first device by adding an external bias to the model of the first device, comprising a first series of steps, wherein, at each step in the first series, a biased model is obtained by computerized solving the system of the equations with an external bias, wherein at a first step in the first series the computerized solving uses the model of the first device and at each next step in the first series the computerized solving uses the biased model obtained at a previous step in the first series, and wherein at each next step in the first series the external bias is greater than or equal to the external bias at a previous step in the first series;

(c) correcting the biased model obtained at a last step in the first series, comprising a second series of steps, at each step in the second series a corrected model is obtained by computerized solving the system of the equations with an external bias, wherein at a first step in the second series the computerized solving uses the biased model obtained at the last step in the first series and at each next step in the second series the computerized solving uses the corrected model obtained at a previous step in the second series, and wherein at each next step in the second series the external bias is less than or equal to the external bias at a previous step in the second series; wherein values of the selected parameters change along the second series of steps so as to reach the semiconductor-device values, and a last corrected model in the second series is a model of the semiconductor device; and,

(d) forming an output based on the model of the semiconductor device for comparison with desired behavior of the semiconductor device.

### BRIEF DESCRIPTION OF THE DRAWINGS

The invention will be described in greater detail with reference to the accompanying drawings which represent preferred embodiments thereof, wherein:

FIG. 1 is a flow chart of a method of simulating a semiconductor device;

FIG. 2A is a flow chart of a non-linear solver;

FIG. 2B is a flow chart of a method of solving Semiconductor Drift-Diffusion (DD) equations;

FIG. 3 is a plot of a contact current in dependence of a contact voltage during a simulation of a GaN diode;

FIG. 4 is a band diagram of the low-current device at point A;

FIG. 5 is a plot of an internal potential of the low-current device at point A;

FIG. 6 is a band diagram at point B;

FIG. 7 is a plot of an internal potential at point B;

FIG. 8 is a band diagram at point C;

FIG. 9 is a plot of an internal potential at point C;

FIG. 10 is a band diagram of a thyristor;

FIGS. 11 and 12 are current-voltage curves on a logarithmic scale of the thyristor using the original and reduced bandgap values;

FIG. 13 is a flow chart of the biasing algorithm; and,

FIG. 14 is a schematic representation of taper lines between two segments.

### DETAILED DESCRIPTION

A method of simulation a semiconductor device employs a device substitution technique, starting with a model of a device which is structurally similar to the target device but has some material parameters altered to make its simulation easier. By way of example for a wide-bandgap device a substitution device would have a reduced bandgap. The method simulates applying an external bias, such as a bias voltage, to the substitution device and, after the electric current increases, the model is modified by gradually correcting the previously changed material parameters so as to arrive at the target device being simulated.

In other words, the method directs simulation steps from the initial approximation, which is the substitution device, not to the target device as it is done in conventional methods, but in detour through the substitution device having high current values. The detour allows to bypass a region where numerical convergence is very slow and/or difficult and eventually arrive at the model of the target device.

The difficulty of simulation of semiconductor devices relates to the issue of whether the current can flow easily across interfaces. In devices with a wide bandgap, the effective barrier height between materials can be large compared to the thermal energy of the carriers kT. The barrier height between two materials is roughly on the order of the difference in the bandgap energies. The alignment of the conduction (electron) and valence (holes) bands depends on the materials involved, their respective electron affinity and various interface effects. This is an intrinsic material property and the two band offsets sum up to the bandgap difference of the materials. In other words, the bandgap difference is split between the conduction and valence band offsets. In materials with Type II band alignment the barrier height is larger than the bandgap for one of the bands due to the large difference in electron affinities between the materials and other interface effects; the other band will have a negative value of the barrier to compensate. However, this rough approximation on the barrier height is relatively accurate.

The method disclosed herein allows for modeling of semiconductor devices for which conventional methods fail. The method is especially useful for accommodating for large material bandgaps, barriers caused by material boundaries, doping profiles, fixed piezoelectric interface charges and other current-blocking effects. By way of example, the method provides computerized models for Avalanche Photodiodes, Silicon Thyristor, strained wurtzite semiconductor devices, Tandem/Multi-Junction devices, and GaN diodes.

The device models obtained by computer simulation may be used for virtual prototyping which is a cost effective way for testing out design ideas before fabrication. Models are also frequently used to investigate the causes of device failures or of inconsistent performance. The simulation may also be used for increasing the device yield, the percentage of devices per wafer that perform according to the design specification. By virtually modifying material parameters or device physical features so that they vary close to the predicted or desired design, one can see the effect of that parameter on the device performance. Accordingly, some aspects of a device design and manufacturing should be controlled to an extra degree so as to ensure a proper yield. Alternatively, the design of the semiconductor device may be modified to remove this particular weakness. Semiconductor devices designed and manufactured with the help of the method disclosed in this application may be used in computers, smartphones, lasers, control electronics/ICs for cars, etc.

A semiconductor device has material parameters such as bandgap, electron affinity, carrier mobilities (electrons/holes), electric permittivity, recombination coefficients, carrier lifetimes, and carrier effective mass (electron/holes), depending on a particular material such as silicon or gallium nitride.

A model of the semiconductor device includes its functional characteristics, e.g. distribution of the potential V, predicted on the basis of the device parameters. The model may be determined by solving a system of equations which includes Semiconductor Drift-Diffusion (DD) equations in the form (1)-(5) or in any other form suitable for the particular semiconductor device. Equations (1)-(5) include system variables being solved, such as potential and either the quasi-Fermi levels or the carrier density—both can be used interchangeably, and various functions of those variables. The quasi-Fermi levels are measured from their respective band edges (conduction or valence) and thus depend on the bandgap and band offsets as a means of setting the reference point for the energies. Functions in (1)-(5) which depend on the quasi-Fermi levels include the electron and hole concentrations n, p found through the Fermi-Dirac integral, the shallow donor and acceptor occupation functions f_{A} and f_{D}, and the currents which are proportional to the gradient of the quasi-Fermi levels and the local carrier density, also a function of the quasi-Fermi levels.

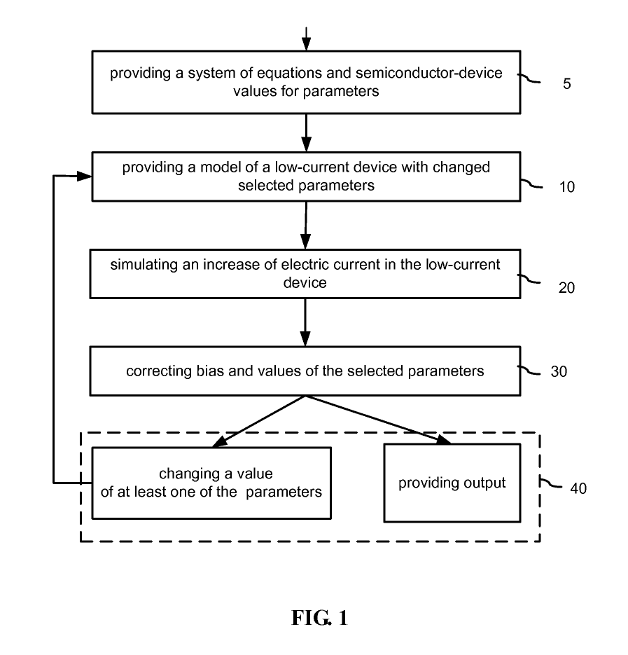

FIG. 1 is a flow chart of a method of simulating a semiconductor device; the method includes an initial setup step 5, a low-current device step 10, a current-increasing step 20, a correction step 30, and a result step 40.

The initial setup step 5 includes providing a system of equations having device parameters, and providing semiconductor-device values for the device parameters. Preferably the system of equations includes the DD equations in the form (1)-(5) or any other form known in the art because the DD approach is known to satisfactory describe the functionality of semiconductor devices.

The low-current device step 10 includes providing a model of a first device also referred to as a low-current device. The model includes the device parameters, which include selected parameters and non-selected parameters. The non-selected parameters of the first device have the semiconductor-device values and the selected parameters of the first device have first-device values different from the semiconductor-device values for the selected parameters. The model of the first device is a solution of a system of equations including the device parameters. The solution may be found analytically at the equilibrium when the electron and hole currents are exactly matched so that the net current is zero and when the quasi-Fermi levels Fₙ=Fₚ=0 everywhere in the device. The solution may also be found numerically at the equilibrium; in this case only the Poison equation (1) needs to be solved to find the potential distribution of the potential V. Alternatively, the solution may include non-zero current which is relatively low, e.g. below a predefined low-current threshold which may be at least 10 times less than the high-current threshold.

In the low-current device step 10, values of one or more selected parameters are changed. By way of example, the bandgap and parameters dependent thereon may be changed. In another example, the doping concentration and bandgap parameters may be altered at the same time to improve the current flow.

The current-increasing step 20 includes introducing a bias into the model of the low-current device so as to increase the values of the electric current. The external bias can be understood as any external stimulus which perturbs the device away from its equilibrium state. By way of example, the bias may be an external voltage or electrical current that is applied to the device, an input of light energy (i.e. “optical pumping”) or an external thermal gradient. All of these effects can be represented numerically by altering the boundary conditions of the model.

An increase of an electric current in the first device by adding an external bias to the model of the first device is simulated through a first series of steps. At each step in the first series, a biased model is obtained by computerized solving the system of the equations with an external bias. At a first step in the first series the computerized solving uses the model of the first device and at each next step in the first series the computerized solving uses the biased model obtained at a previous step in the first series, and wherein at each next step in the first series the external bias is greater than or equal to the external bias at a previous step in the first series.

The correction step 30 includes correcting the bias and values of the selected parameters in the biased model obtained at a last step in the first series.

More specifically, the correction step 30 includes a second series of steps, at each step in the second series a corrected model is obtained by computerized solving the system of the equations with an external bias. A first step in the second series the computerized solving uses the biased model obtained at the last step in the first series and at each next step in the second series the computerized solving uses the corrected model obtained at a previous step in the second series. At each next step in the second series the external bias is less than or equal to the external bias at a previous step in the second series. Values of the selected parameters change along the second series of steps so as to reach the semiconductor-device values, and a last corrected model in the second series is a model of the semiconductor device.

In the result step 40, the model of the semiconductor device is used to form an output for outputting the output to a user, or to another program or device. The user may compare the output results to expected behavior of the device, use the parameters for manufacturing of the device, or may change values of the device parameters. Alternatively, a value of at least one of the selected or non-selected parameters is changed and the steps 10 through 30 are repeated, which enables automatic improvement of the device design with respect to a predefined criterion.

The aforedescribed method may be performed at a general purpose computer, a specialized computer, a supercomputer, or a computing cluster. In cluster supercomputing, a master node may compute the Jacobian sparse matrix and then separate the work of doing the linear solution unto multiple slave nodes.

Preferably the entire method is performed by a same computer; however, distributed computing may be employed so that the method steps are performed by several processors and the intermediate results are stored in the combined memory of the distributed system. The computer system may include one or more processors for executing the method, a memory including RAM for storing at least the models sequentially simulated by the method, and an output device for providing the output to a user, by way of example a display or plotter. A linear solver is used by the non-linear Newton method. The linear solver may be implemented in software, firmware, and/or hardware. By way of example, a video card (GPU) may be used as a math co-processor for performing the linear solver part of the Newton non-linear solver.

The method may be implemented in a computer program product including a non-transitory computer readable medium having a computer readable program recorded thereon, wherein the computer readable program, when executed on a computing system, causes the computing system to accept semiconductor-device values for device parameters; simulate an increase of an electric current, then correct the bias and values of the selected parameters, and provide an output based on the model of the semiconductor device, as described herein with reference to FIG. 1.

The program is a set of instructions for execution by one or more processors of the computing system which is referred herein as “a computer”. The models obtained by computerized solving the system of the equation as described above may be stored in the memory of the computer, e.g. in RAM, and be overwritten by a next model produced by the method.

The semiconductor-device values may be provided to the program via an input module of the computer, such as a keyboard, or a communication port connected to another device, or from another program e.g. configured to improve the design of the semiconductor device.

The non-transitory readable media may comprise any computer-readable media, with the sole exception being a transitory, propagating signal. The non-transitory readable media may be computer-readable memory of the modeling system, several of which are familiar to those of skill in the art, or in a computer-readable storage device, such as a magnetic disk or optical disk or other tangible memory.

The aforedescribed method may be used for designing a semiconductor device; an output formed based on the model of the semiconductor device may be used for comparison with desired device behavior and for changing values of the device parameters so as to achieve or approach the desired device behavior.

The aforedescribed method may be used to provide a model of a GaN diode on the basis of the system of DD equations.

The selected parameters include the bandgap parameter E_{g} and parameters dependent on the bandgap. These parameters are changed along the method steps as described above with reference to FIG. 1. The non-selected parameters may be all the remaining device parameter which do not depend on the bandgap.

In the low-current device step 10, we provide a model of a low-current device wherein the bandgap parameter is 50% of the bandgap of the GaN diode. The model of the low-current device may be an analytical solution of the system of DD equations found at the equilibrium; this low-current device is also referred to as an equilibrium device.

Generally, the bandgap parameter in the low-current device should be at least 10% less, and preferably 50% less, than the value of the bandgap in the target device. In the following method steps, the computerized simulation of the low-current device with a reduced bandgap (a low-bandgap device) is numerically simpler than simulation of the target wide-bandgap device, the GaN diode in this case. In materials with large bandgaps, wide variations in the quasi-Fermi level produce carrier densities so low that they have almost no effect on the equation residue. The system of DD equations in such a case has multiple, relatively-close solutions which impede obtaining a numerically stable solution. A large bandgap value means that the carrier densities and the currents are very low (due to Fermi-Dirac terms and difference between quasi-Fermi level and band edge energies). The device with a reduced bandgap will therefore have a lower turn-on voltage.

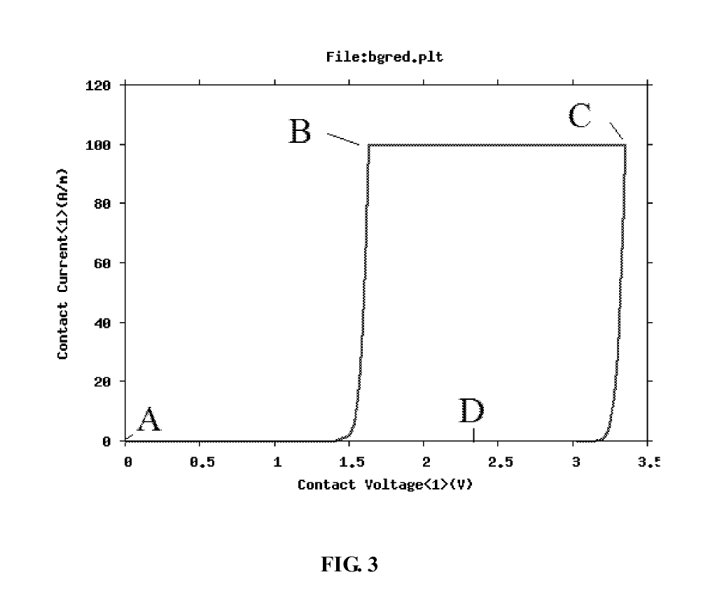

FIG. 3 is a plot of a current-voltage curve representing the method of simulation the GaN diode. A point A represents the low-current model, also referred to as the equilibrium solution found in the low-current device step 10 by using bandgap values that are 50% of the original.

In the current-increasing step 20, an external bias in the form of voltage is zero at the point A and increases between the points A and B until a desired current or voltage value has been reached. A predefined high-current threshold value may be used to terminate the first series of modeling steps, at each step increasing the bias applied to the system of equations (1)-(5) by altering the electrical boundary conditions, in order to get the electric current of each next model greater than the electric current in the model at the previous step in the first series; the electric current in the last model is above the predefined high-current threshold. The bias may be introduced in the boundary condition discussed in more details with reference to Eqs. (26)-(34) wherein the value of the applied voltage parameter V_{applied} increases for each next model in the first series resulting in the growth of the electric current along the line AB.

In this example, at each simulation step in the first series, the selected parameter (bandgap) and parameters dependent on the bandgap have the value of the low-current device, and all remaining non-selected parameters have the values of the target semiconductor device simulated by the method.

The correction step 30 includes correcting values of the selected parameter (bandgap) in a first subsequence of simulation steps while the bias does not change. The correction step 30 further includes correcting the bias in a second subsequence of simulation steps while the selected parameters, the bandgap and parameters dependent n thereon, do not change.

The first subsequence of steps is represented in FIG. 3 by an interval BC, and the second—by the interval CD.

Between the points B and C, the bandgap value is progressively restored to its original, semiconductor-device value, and the voltage is increased while preferably keeping the current value unchanged from one model to another.

The simulation steps along the onterval AC allow to get to the point where we can start decreasing the voltage. Between the points C and D, the bias value is gradually reduced, preferably to zero. However a convergence failure may happen before reaching the zero bias (voltage) so that the bias is to be reduced as much as possible while the computerized solving of the system of equations may be achieved.

In other words, FIG. 3 shows a trajectory of the device in the current-voltage plane when the method described with reference to FIG. 1 is applied to a GaN diode so as to obtain a model of the GaN diode (point D). The method starts with an equilibrium/low-current device (point A), moves to B with increase of the voltage bias, then moves to C while the bandgap value previously altered in the equilibrium device returns to its value, and finally from C to D by removing the bias.

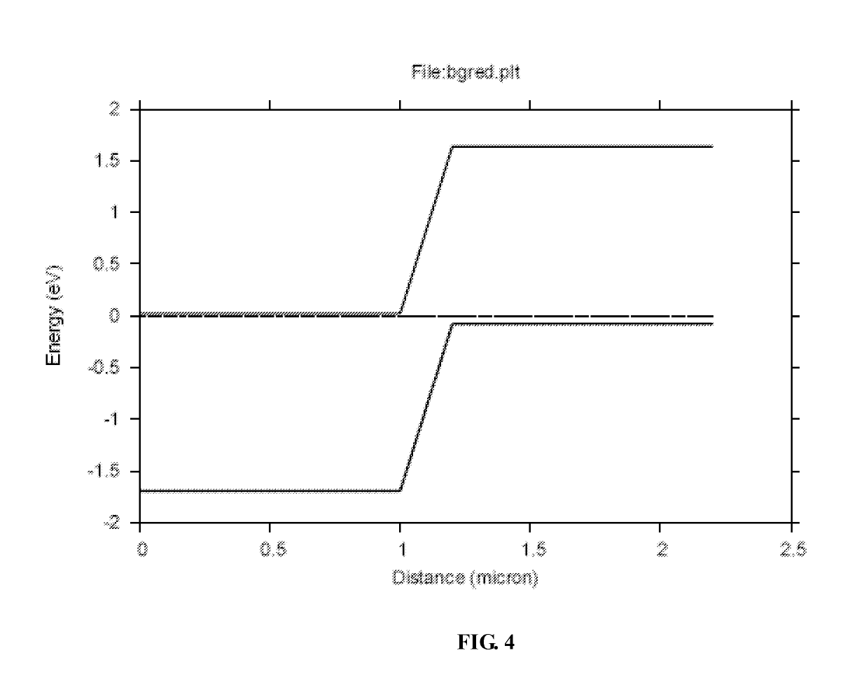

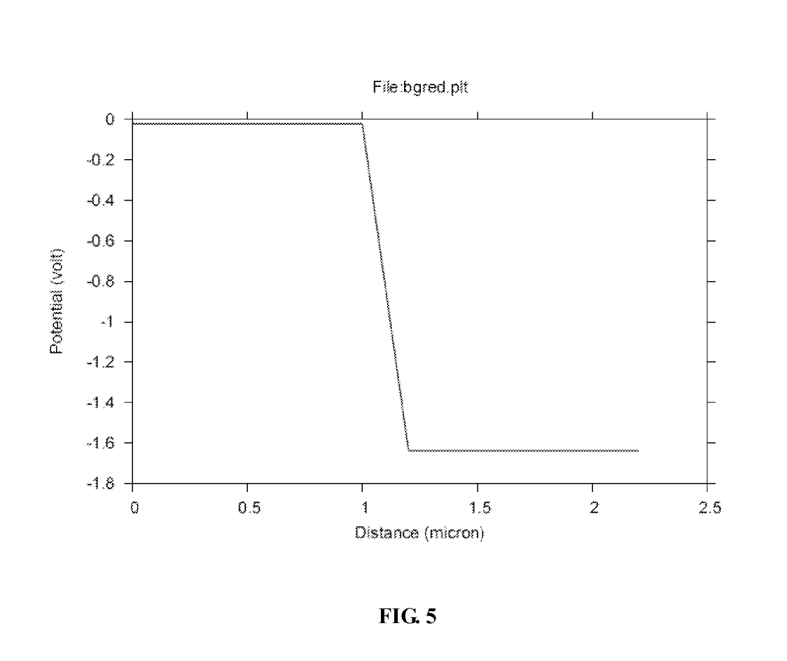

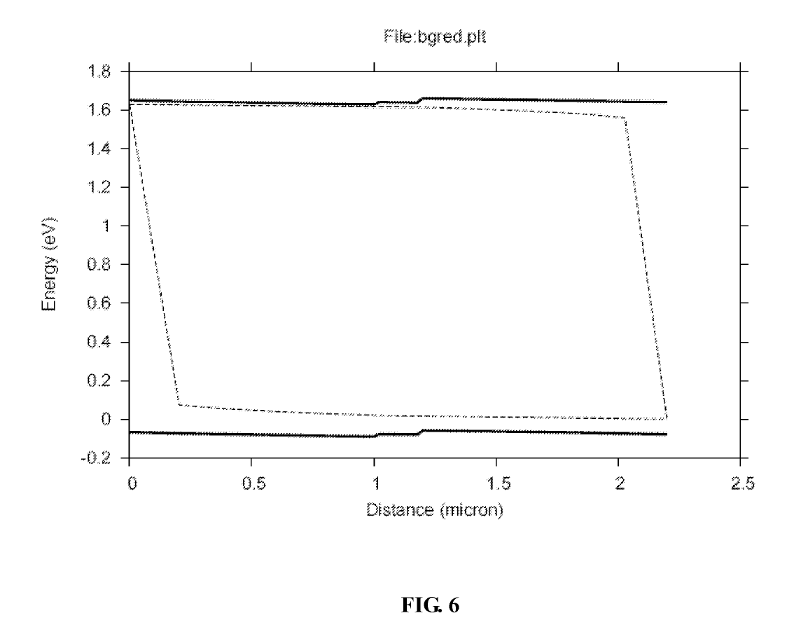

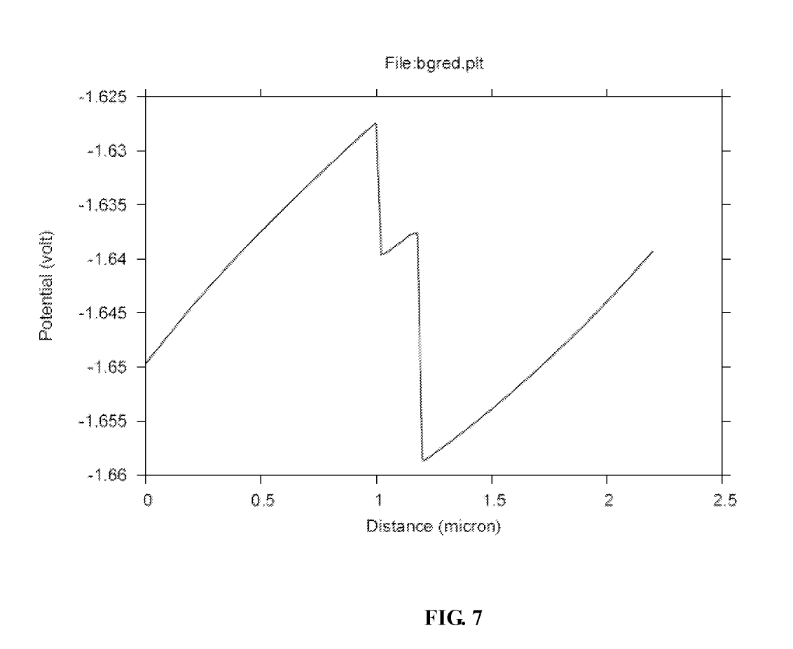

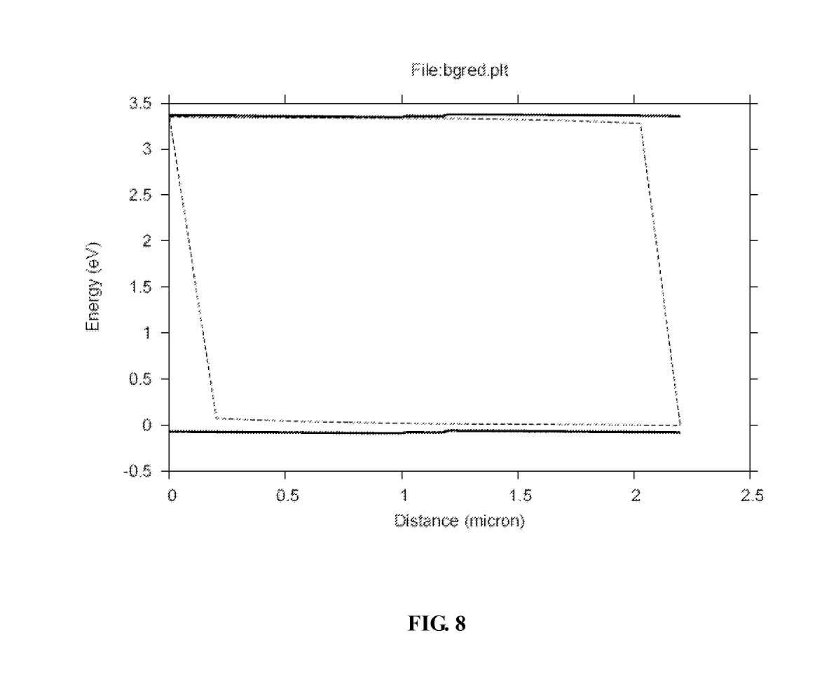

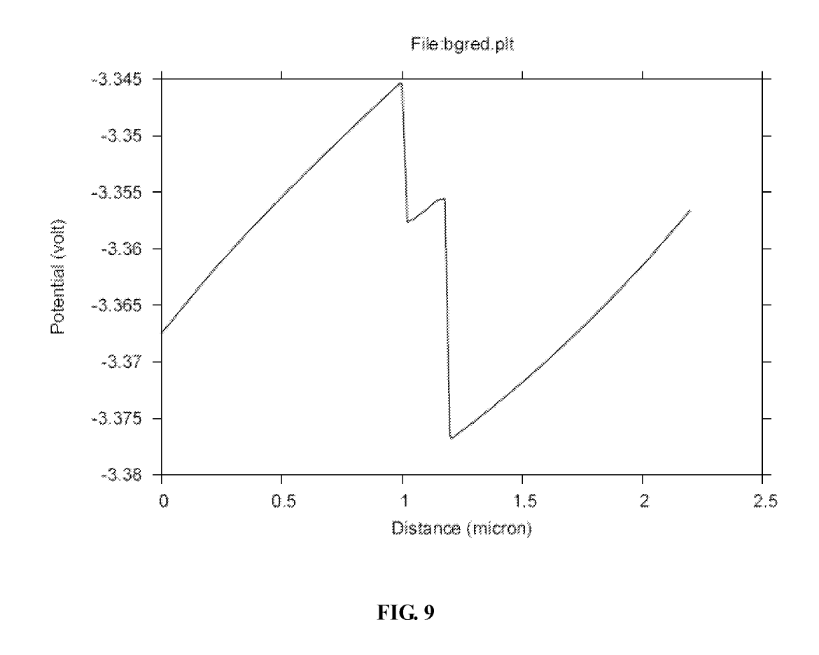

The model of the low-current device, which is a solution of the system (1)-(5) at or near the equilibrium, is shown in more detail in FIGS. 4-5 which are band diagram and internal potential plots under equilibrium conditions. FIGS. 6-7 are band diagram and internal potential plots at point B, and FIGS. 8-9 are band diagram and internal potential plots at point C.

The method outlined above with reference to FIG. 1 will be described in more detail.

For N mesh points, there are at least 3N equations to consider. The numerical solution method is based on the well-known Newton-Raphson method. Once discretized over a finite element/finite volume mesh, the above equations are rewritten as sets of coupled equations:

Fᵥ^{j}(V^{jk},E_{fn}^{jk},E_{fv}^{jk})=0

Fₙ^{j}(V^{jk},E_{fn}^{jk},E_{fv}^{jk})=0

Fₚ^{j}(V^{jk},E_{fn}^{jk},E_{fv}^{jk})=0

where j=1 . . . N is the mesh point number, jk refers to mesh point j and all surrounding mesh points and (V¹,E_{fn}¹, E_{fp}¹, . . . , V^{N}, E_{fn}^{N},E_{fp}^{N}) are the potential and quasi-Fermi levels for electrons and holes at all mesh points. These δN variables form the solution to the Drift-Diffusion equations at a given external bias.

The equations may be re-written in the matrix form, and we assume the existence of an unknown solution vector X which satisfies all equations above so that F(X)=0. The Taylor expansion in the neighborhood of this unknown solution gives F(X+δX)=0+JδX, where the Jacobian J is evaluated at the solution point. So given an estimate of the solution X that is sufficiently close to the real solution that the Jacobian is the unaffected, the exact solution is given by:

X=X−J⁻¹F(X).

which is solved by iterations of a nonlinear solver:

Xₙ₊₁=Xₙ−Jₙ⁻¹F(Xₙ).

The convergence criterion can either be set to a maximum value of the function residue F(Xₙ), a limit on the relative change in the solution estimate between iterations (Xₙ₊₁−Xₙ), or both. Overall convergence of the nonlinear solver depends on providing an initial approximation of the solution that is close enough to the actual solution that the residue F(X) is small and the Jacobian does not deviate too much from its unknown “linear” value. A limit on the size of the update step (aka “damping”) such as those found in globally convergent methods is used to prevent the iterations from diverging at the cost of a slower rate of convergence.

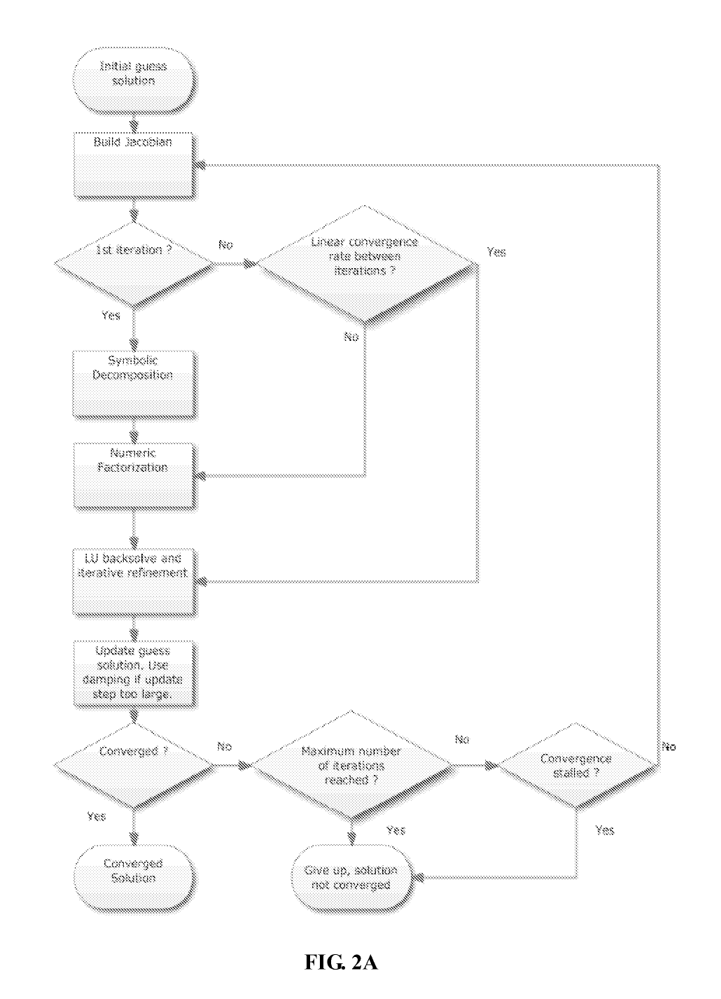

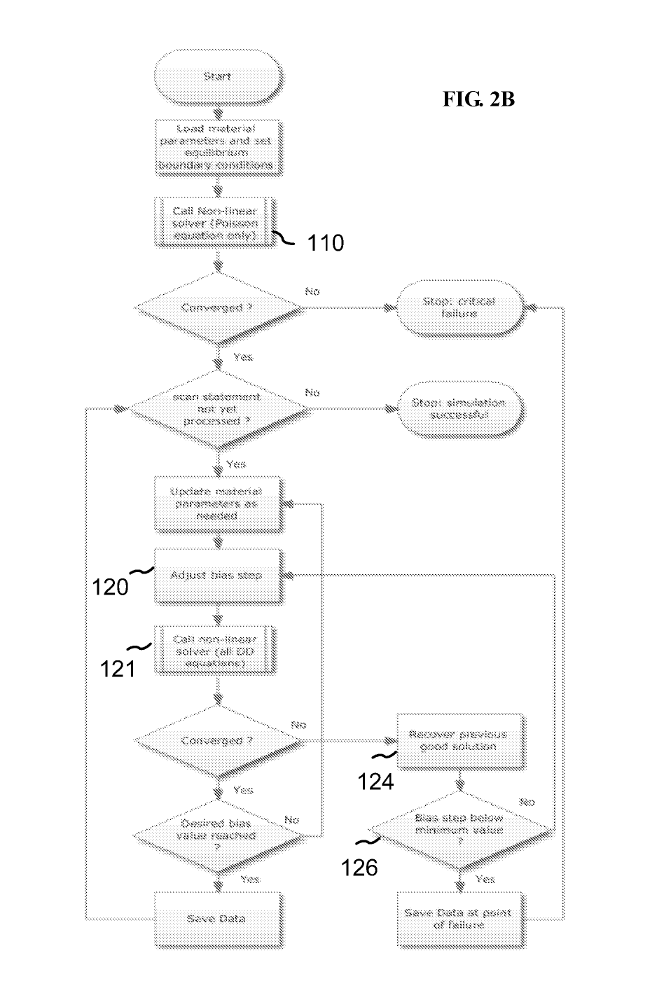

With reference to FIG. 2A, the nonlinear solver includes symbolic decomposition, numeric factorization (LU), backsolve and iterative refinement steps. These may be performed at every iteration but modern solving techniques reuse some results from previous iterations whenever possible to save on computation time. For large problems, the symbolic decomposition and numeric factorization steps are especially expensive and care should be taken to do them only as necessary. The Jacobian matrix on which the solver is used depends on the equations being solved.

FIG. 2B is a flow chart of the method of solving the system including the DD equations. In the low-current device step 10 (FIG. 1), the initial approximation may be obtained by solving the system under equilibrium conditions. Thermodynamic equilibrium can be defined as the natural state of any object which is not subjected to any kind of external disturbance like heat, chemical processes or electric current. Since by definition, all current terms are zero at equilibrium, only the Poisson equation needs to be solved in an equilibrium nonlinear solver step 110. This simplification of the problem makes it possible to converge on the equilibrium solution even with a relatively imprecise initial approximation.

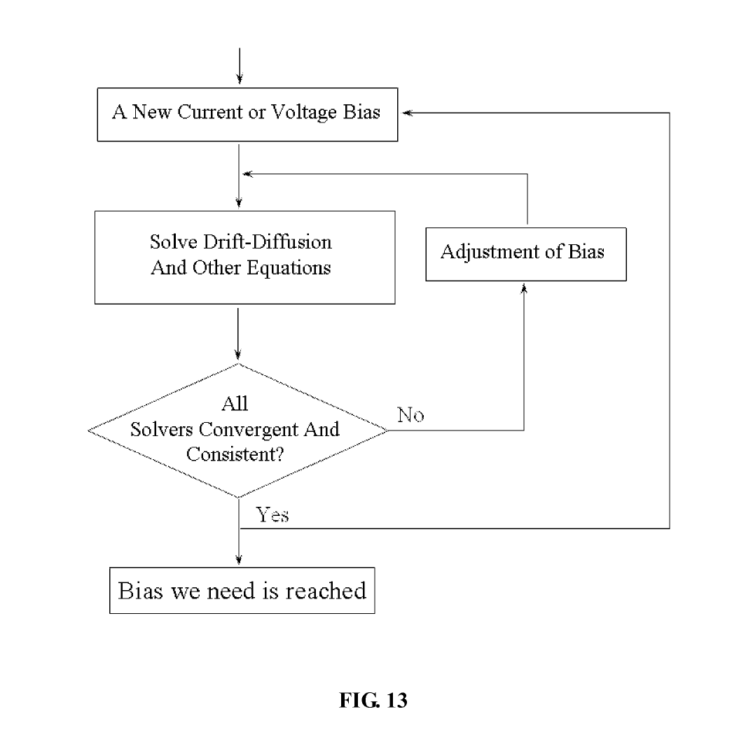

Once convergence is achieved for the equilibrium, a bias step is applied in a bias step 120 and the nonlinear solver starts again in a biased nonlinear solver step 121: the previous solution is used as the new initial approximation. FIG. 13 illustrates the biasing strategy in more detail. The term “bias” means anything that moves a device away from equilibrium. This can be a voltage or current applied to the electrodes, a temperature difference/gradient between sections of the device or an external light source (as in solar cells). Altering the bias of the device means that numerically, the boundary conditions of the problem being solved. The previous solution is used as the initial approximation for the new solution since the change in boundary conditions means that the old solution no longer satisfies the DD equations at this bias.

Once enough data has been accumulated, the solution is extrapolated between successive bias steps to provide a better solution estimate and speed up convergence in an extrapolation step. In case of divergence, the previously converged solution is recovered in a recovery step 124, and a smaller bias step (the bias step 120) is used to extrapolate a new estimate of the solution. This process continues until the desired bias is reached or the size of the bias step falls below a certain limit, step 126. The bias step 120, biased nonlinear solver step 121, extrapolation step, and recovered in a recovery step 124 are parts of the current-increasing step 20 (FIG. 1).

The bias range depends on the device and materials being used. Some applications (high power transistors) use voltage values in excess of 100 Volts while others (vertical cavity lasers) can only tolerate small current values (a few mA so voltage is also low).

There are a number of challenges to achieving convergence of the nonlinear solver with the Drift-Diffusion equations:

(1) The equations are highly nonlinear and convergence strongly depends on the quality of the initial solution estimate. It is quite common for the iterations to oscillate or diverge if a bad initial approximation is provided or the damping value is too large.

(2) Extrapolating the solution of a previous bias step to provide this estimate only works for small bias steps since it is a form of linearization. Many terms in the equations such as the carrier and photon densities can vary exponentially and change by several orders of magnitude depending on the applied bias.

(3) In sparsely populated regions or materials with large bandgaps, wide variations in the quasi-Fermi level will produce carrier densities so low that they have almost no effect on the equation residue. Multiple valid solutions may be found which makes it difficult to obtain a numerically stable solution.

(4) In devices with low steady-state currents, the terms of the carrier continuity equation may all be close to zero. This can result in singular matrices and lack of numerical precision and can skew the solution update and ruin the convergence of the nonlinear iterations.

(5) Sharp variations in material parameters can create large residues in the discretized equations if the local mesh density is not sufficiently dense.

Often, convergence problems can be due to several of these reasons. However, most of these issues can be reduced to one essential element: a lack of continuity. The Drift-Diffusion equations enforce continuous current flow like those found in fluid media: anything that does not conform to this hypothesis can cause convergence problems.

It is desirable to solve these convergence issues so that to enlarge the variety of semiconductor devices that can be successfully modeled. Extensive research has been done on solving the convergence issues and improving the accuracy of linear solvers including pivoting strategies, preconditioners and iterative refinement techniques. Current research is mostly focused on developing parallelization techniques to improve performance on modern computer architectures such as clustered supercomputers and multi-core CPUs.

However, non-linear solvers are not yet well understood. Conventional techniques to improve convergence almost always rely on refining the mesh/re-gridding in order to improve continuity. This approach only helps with point #5 listed above and may be numerically intensive since it requires using more mesh points. It has no effect for cases where the lack of convergence is caused by the lack of numerical precision such as in low-current or current-blocking situations. Arbitrary-precision arithmetic has also been suggested as a solution to certain convergence problems but it is currently much slower than the IEEE floating point standard on commonly-used architectures which makes its use impractical.

The method suggested by the inventors addresses points #3 and #4 by working around the numerical precision problems without using the arbitrary-precision arithmetic. Re-gridding is also not necessary although it can be used to supplement the techniques described herein and to improve the accuracy of the simulation results.

By making the problem easier to converge, we reduce the number of iterations necessary in the non-linear solver to reach a converged solution. We also reduce the number of retries due to the failure of the non-linear solver. This speeds up simulation and thus increases the productivity of semiconductor device designers using TCAD tools.

The method described above with reference to FIG. 1 may be used for simulation of the following semiconductor devices which previously known methods failed to simulate, or the simulation process was impractically demanding.

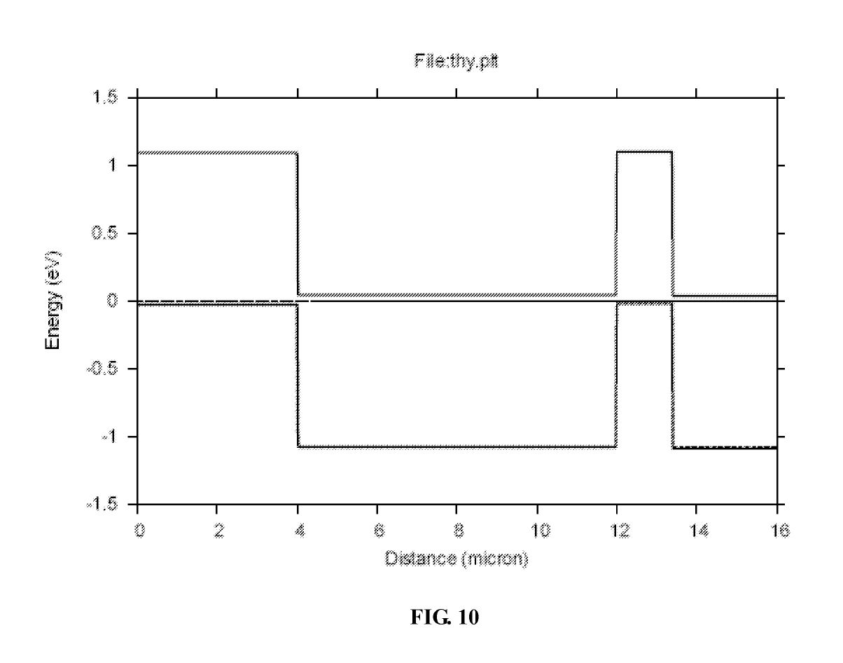

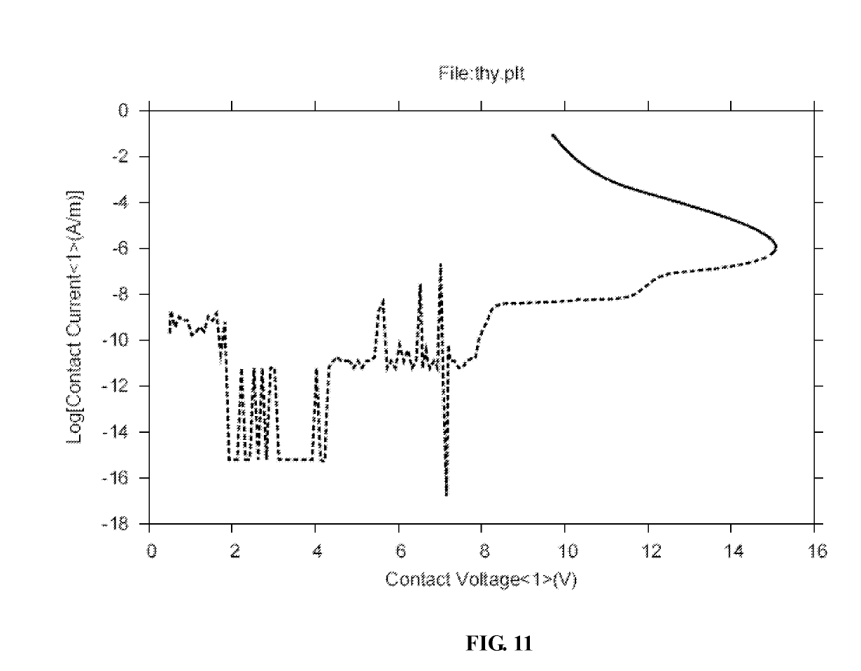

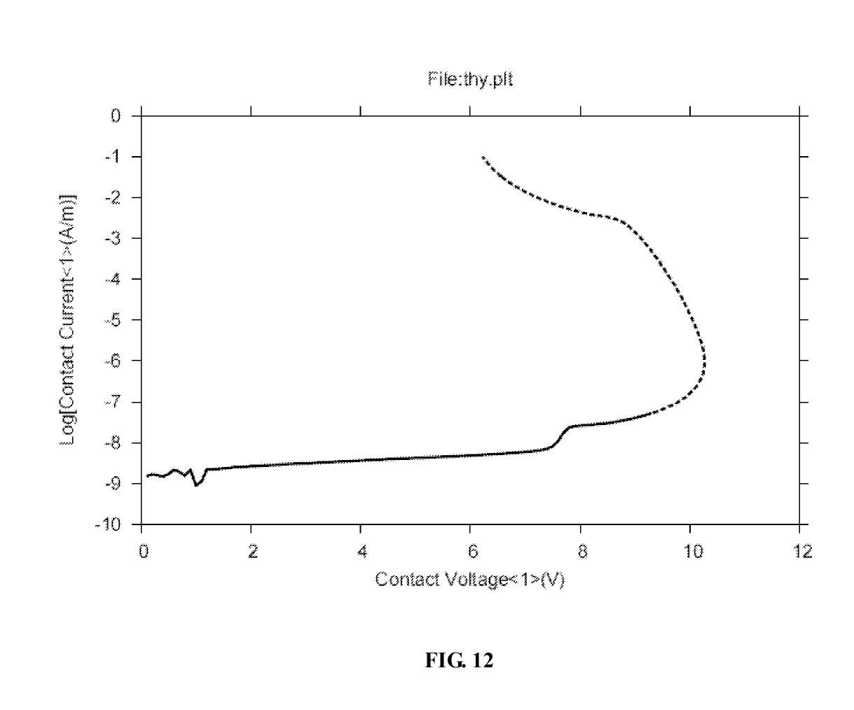

A silicon thyristor is a device doped n+−p+−n+−p+: forms back-back diodes in opposite directions which block current at low bias. The silicon thyristor is a bistable device with multiple solutions (low/high current) depending on the bias state: the current-voltage curve shows a S-shape. FIGS. 10 and 11 show results for original bandgap values (FIG. 10) and reduced bandgap (FIG. 11). The large fluctuations in the electric current in the former indicate unstable solutions and, thus, slow convergence. FIG. 11 shows significant improvement due to using a reduced bandgap in the method step 10.

Avalanche photodiodes are very difficult to simulate using conventional methods, because between the equilibrium and the avalanche region, there is a low-current regime where it is hard to converge. The avalanche starts when the reverse voltage is strong enough to create the required electric field intensity (breakdown voltage). The structure of an avalanche photodiode is basically the same as of any other p-i-n diode. Some small modifications might be made to allow the device to survive being operated in the avalanche regime which might be destructive over the long term for a normal diode. However, an avalanche diode is operated using reverse voltage. Accordingly, the bias applied at the current-increasing step 20 is the reverse voltage. The magnitude of the electric current is extremely low until a high reverse bias is reached and avalanche effect kicks in.

Tandem/multi-junction devices include light-emitting diodes, lasers and solar cells: there are multiple p-n junctions connected by heavily doped p++ and n++ regions. The heavily doped n++ and p++ regions provide an interband tunneling mechanism so that hole current from one junction is converted to electron current in the next junction (and vice versa). At high bias, each junction will be biased in a forward or reverse direction (depending on the kind of device) but at low bias, this distinction may be harder to make: back-to-back diodes in opposite directions may block the current completely. Lowering the doping of the tunnel region helps bypass the low-current region and get current flowing in the right direction. Restoring higher doping in the tunnel region will restore the correct bias on the individual p-n junction while keeping the current flow in the right direction.

Strained wurtzite semiconductor devices are based on wurtizte crystals such as GaN, InGaN, AlGaN and ZnO which have spontaneous and strain-induced polarization. Mismatch of crystal lattice parameter in hetereojunctions contributes a polarization mismatch and creates interface charges. These bend the bands and introduce barriers to the current flow. Artificially lowering the surface charge density reduces the amount of band bending and lowers the barriers.

The device substitution technique, i.e. starting the simulation process with a model of a semiconductor device where values of selected parameters such as bandgap differ from the values in the target device, is useful when dealing with large material bandgaps, barriers caused by material boundaries, doping profiles, fixed piezoelectric interface charges and other current-blocking effects.

A slow transient technique is an extension of the commonly-used transient analysis. In a normal steady-state solution, all

$$\frac{\partial }{\partial t}$$

terms in the equations being solved are set to zero. When transient modeling is needed, the

$$\frac{\partial }{\partial t}$$

terms are also discretized in time using the numerically stable backward Euler method:

$$\frac{\partial S}{\partial t} = \frac{S ( t ) - S ( t - Δ t )}{Δ t} .$$

We note that

$${lim}_{Δ t -> ∞} \frac{\partial S}{\partial t} = 0 ,$$

in which case the equations being solved are exactly the same as for steady-state. For finite time steps, the solution method is the same and only a few additional terms are present in the equations.

It is this observation which inspired the slow transient method. In most applications of transient analysis to semiconductor modeling, the time scale of the simulation is well below 1 microsecond and fast-switching transistors involve time scales of a few picoseconds. Indeed, carrier lifetimes are typically on the order of a few nanoseconds so after some initial transient effects when bias changes, it is commonly accepted that not much time is needed to reach a final ready-state solution.

However, the slow transient method deliberately avoids using these time scales since it is not used to obtain transient properties. Instead, it is used to approximate the steady-state solution: for time steps that are much larger than carrier lifetimes, the transient current terms (also referred to as displacement current) are much smaller than the steady-state current terms. However, in regions where there is current blocking or where the steady-state current is low the opposite is true. It is thus possible to use transient current terms to enforce the current continuity in regions where the steady-state current is smaller than the numerical precision.

The choice of time scale is important in a slow transient simulation. Too small and the transient terms will perturb the steady-state solution too much; too large and the transient terms will also fall below the limit of numerical precision. The exact choice depends on the carrier lifetimes of the materials used in a given semiconductor device: typically, a value of ˜1 second will result in a reasonably small perturbation of the steady-state solution (approx. 1 e-9).

The Slow Transient technique has been used to solve known difficult problems such as floating gate in MOSFET, organic semiconductors and highly insulating devices. It can also help with switching in bistable devices when the two steady-state solutions are highly dissimilar.

There are many applications of the slow transient technique but one practical example is the aforementioned floating gate problem. To describe the device in simple terms, a floating gate transistor is a device with 3 metal contacts, A on the left, B in the middle and C on the right. Contact B is physically and electrically separated from the rest of the device (usually by an oxide layer). Contact B acts a bit like a capacitor in that it cannot inject any current but its bias value can affect the internal potential of the device. Let us assume that voltage on A=0 V and voltage on C=10 V. If contact B is not connected to any external potential, a simple model and manual calculation would indicate a value of B be around 5 V, somewhere in the middle of the other two values.

However, the numerical equations do not necessarily lead to this solution: there are many valid solutions on which the Newton method might converge. For example, it could find the voltage on B to be +50 V or even −100 V. The current between the electrodes would be completely different in either case but they would both satisfy the equations being solved. These spurious but numerically valid solutions make convergence difficult and unstable since the Newton method may oscillate between different solutions.

When the slow-transient method is applied, the extra time-dependent terms eliminate most of the spurious solutions. The explanation is that these time-dependent derivatives model the charging and discharging process of the effective capacitor at electrode B. These effects are not included in the steady-state model which allows the spurious solutions to exist.

The method may be implemented in a set of computer programs and routines written in Fortran and C/C++. Said program shall be controlled by a text-based or graphical interface that allows the user to:

Specify the control parameters of the non-linear solver including but not limited to the convergence criterion to be used and damping value between non-linear iterations;

Command the solver to solve the Drift-Diffusion equations under equilibrium conditions;

Command the solver to alter the applied bias and solve the Drift-Diffusion equations using the solution from previous bias values as an initial solution estimate.

These steps are implemented in the commands “newton_par”, “equilibrium” and “scan”, respectively. The current-voltage curve of FIG. 3 is an example of the device substitution technique and was generated using the following syntax:

TABLE 1
Device Substitution technique used to reduce and restore material bandgap

newton_par damping_step=5. max_iter=100 print_flag=3
equilibrium bandgap_reduction=0.5
newton_par damping_step=1. print_flag=3
scan var=voltage_1 value_to=−10 max_step=0.1 &&
auto_finish=current_1 auto_until=0.1 auto_condition=above
scan var=current_1 value_to=100 max_step=1.0
scan value_to=0 var = bandgap_reduction &&
var2=current_1 value2_to=100
scan var=current_1 value_to=0.0

The steps involved in the device substitution techniques are to solve the Drift-Diffusion equations for an artificially simplified version of the device under equilibrium conditions. Then bias is applied until a sufficiently high current value is reached. The artificial simplification is then progressively removed while maintaining a sufficiently high current value, which is determined by comparing the in-flowing and out-flowing currents on the electrodes. By Kirchoffs current law, the sum of these currents should be exactly zero but that is not the case when the current is low due to the lack of numerical precision. When there is sufficient current, the sum is zero (within a certain tolerance) and convergence is usually easier. This data may be output to help the user to control the simulation interactively. In the final step, bias is applied to the original device in order to study a particular bias range while avoiding the non-converging low-current region.

The slow transient technique uses the same interface and underlying software code as the device substitution technique. The slow transient technique may be implemented by adding a time variable to the “scan” statement. This variable is considered as a form of bias and is increased as the same time as the applied voltage or current. An example of this is shown below in Table 2: the time scale of 1 second is much larger than the value of the carrier lifetime for most semiconductors.

TABLE 2
Example of Slow Transient technique.
scan var=voltage_1 value=−3.5 var2=time value2_to=1.0

In the examples illustrated in Tables 1 and 2, the boundary conditions are specified by the variables “current_{—}1” (current on electrode #1), “voltage_{—}1” (voltage value of electrode #1), “light”, etc.

The method described herein is based on the consideration that DD equations are easier to solve if large amounts of current flows within the device. The implementation of this idea is to set up an easy-to-solve device and use FEM/FVM numerical analysis to obtain the solution of the DD equations. This provides the internal potential distribution of the device and other useful variables such as quasi-Fermi levels that predict semiconductor device performance in real-world applications.

The method can be implemented in a TCAD tool. It may be used in a Windows PC or UNIX-like supercomputer. Its purpose is to assist design and manufacturing of semiconductor devices by virtual modeling of the devices instead of building and testing prototypes in a lab environment which is quite expensive and requires numerous specialized equipment and often done in external facilities.

Advantageously, the method described herein solves problems associated with known simulation algorithms. While it is easy to write a theoretical method to solve these equations, in practice the implementation is very difficult in particular because getting reliable convergence with the drift-diffusion equations under a variety of conditions is a challenge.

The method may be used in semiconductor device manufacturing; it also can be used at the prototype stage, to diagnose performance problems and possible solutions and to optimize device designs, as well as at the quality control stage of the manufacturing process.

Numerical techniques used to fix convergence problems when solving the semiconductor Drift-Diffusion equations using finite element/finite volume analysis include artificial simplification by device substitution and slow transient analysis.

The device substitution technique has been described above with reference to FIG. 1.

The slow transient technique includes solving the semiconductor equations over a long time period in which the semiconductor equations are discretized in time based on the backward Euler method. The time period should be longer than the carrier lifetime in the semiconductor devices, so that the transient effects will be minimal but not long enough that transient terms fall below the numerical precision limit. The time period may be different depending on the device geometry and material composition of the device being modeled.

The variety of phenomena in a semiconductor may be described by a variety of models including the drift-diffusion (DD) model which allows for many characteristics of a semiconductor device such as the capability to amplify electrical signal be explained using the DD theory.

The equations used to describe the semiconductor device behavior are Poisson's equation (1) and the current continuity equations for electrons and holes (2) and (3). These equations govern the electrical behavior (e.g., current-voltage characteristics) of a semiconductor device.

Optionally, two more equations may be used to described the carrier energy (w) or the carrier temperature distribution. This is not to be confused with the lattice temperature; the former is a description of how the carrier distribution deviates from Fermi-Dirac distribution. Such a model is also referred to as the hydrodynamic model.

For simplicity, we only present the equations for hot electrons (the corresponding equations for hot holes are completely analogous):

$$∇ \cdot S + {R}_{n} w - ∇ {E}_{c} \cdot {J}_{n} + \frac{n ( w - {w}_{0} )}{{τ}_{w}} + \frac{\partial ( nw )}{\partial t} = 0 , \\ S = - \frac{5}{3} {J}_{n} w - \frac{10}{9} {μ}_{n} nw ∇ w . \qquad ( 6 )$$

where w is the total energy of an electron, and w₀=3 kT/2 is the electron energy at equilibrium. S is the electron energy flux intensity, and τ_{w} is the energy relaxation time.

The method of numerical simulation of a semiconductor device includes obtaining a model of the device by solving the equations for the electrostatic potential V, the electron and hole concentrations (n, p), and the electron and hole energies (Wₙ,Wₚ).

The carrier flux densities Jₙ and Jₚ in Equations (6) can be written as functions of the carrier concentration and the quasi-Fermi levels:

Jₙ=nμₙ∇E_{fn}, (7)

Jₚ=pμₚ∇_{fp}, (8)

where μₙ and μₚ are mobilities of electrons and holes. For convenience, we use carrier flux density and current density interchangeably even though they differ by a factor of electron charge.

For the hydrodynamic model, the expression for the electron (or hole) current is modified:

$${J}_{n} = {μ}_{n} \{ - n ∇ [ ψ + χ + {γ}_{n} ] + \frac{2}{3} ∇ ( nw ) - nw ∇ ln ( {m}_{n} ) \} .$$

The carrier recombination due to deep level traps (Shockley-Read-Hall (SRH) recombination) is described by:

Rₙ^{tj}=cₙⱼnNₜⱼ(1−fₜⱼ−cₙⱼn₁ⱼNₜⱼfₜⱼ,

Rₚ^{tj}=cₚⱼpNₜⱼfₜⱼ−cₚⱼp₁ⱼNₜⱼ(1−fₜⱼ). (9)

where n₁ⱼ is the electron concentration when the electron quasi-Fermi level coincides with the energy level Eₜⱼ of the jₜₕ trap. A similar definition applies to p₁ⱼ.

Under transient conditions, the following trap dynamic equation is valid:

$${N}_{tj} \frac{\partial {f}_{tj}}{\partial t} = {R}_{n}^{tj} - {R}_{p}^{tj} . \qquad ( 10 )$$

The capture coefficients cₙⱼ and cₚⱼ for electrons and holes relate to the lifetime of the carrier due the j-th recombination center by the following relation:

$$\frac{1}{{τ}_{nj}} = {c}_{nj} {N}_{tj} , \\ \frac{1}{{τ}_{pj}} = {c}_{pj} {N}_{tj} . \qquad ( 11 )$$

Equations (9) to (11) are equivalent to the standard expression of the SRH model under steady state conditions.

The capture coefficients can be further expressed as:

$${c}_{nj} = {σ}_{nj} {\overline{υ}}_{n} , \\ {\overline{v}}_{n} = \sqrt{\frac{8 kT}{π {m}_{n}}} , \\ {c}_{pj} = {σ}_{pj} {\overline{υ}}_{p} , \\ {\overline{v}}_{p} = \sqrt{\frac{8 kT}{π {m}_{p}} .} \qquad ( 12 )$$

A trap (or recombination center) is completely specified by its density Nₜⱼ, capture cross sections σₙⱼ and σₚⱼ, and energy level Eₜⱼ.

The Auger recombination rate is given by

Rₐₙ=(Cₙn+Cₚp)(np−ni²), (13)

where the Auger coefficients Cₙ and Cₚ depend on the type of material simulated.

The electron and hole concentrations in bulk semiconductors are defined by Fermi-Dirac distributions and a parabolic density of states which, when integrated, yield

$$\begin{matrix}n = {N}_{c} {F}_{1 / 2} ( \frac{{E}_{fn} - {E}_{c}}{kT} ) , \\ p = {N}_{v} {F}_{1 / 2} ( \frac{{E}_{v} - {E}_{fp}}{kT} ) ,\end{matrix} \qquad ( 14 )$$

where F_{1/2} is the Fermi integral of order one-half.

For the convenience of numerical evaluation, the Bednarczyk and Bednarczyk approximation is used:

$$\begin{matrix}{F}_{1 / 2} ( x ) \approx {( {e}^{- x} + ξ ( x ) )}^{- 1} , \\ ξ ( x ) = \frac{3}{4} {\sqrt{π} [ v ( x ) ]}^{3 / 8} , \\ v ( x ) = {x}^{4} + 50 + 33.6 x \{ 1 - 0.68 exp [ - 0.17 {( x + 1 )}^{2} ] \} .\end{matrix} \qquad ( 15 )$$

This expression is accurate within 0.4% in all ranges.

In the limit of low carrier concentration, Equations (14) reduce to the Boltzmann statistics:

$$n = {N}_{c} exp ( \frac{{E}_{fn} - {E}_{c}}{kT} ) , \\ p = {N}_{v} exp ( \frac{{E}_{v} - {E}_{fp}}{kT} ) , \qquad ( 16 ) .$$

The simulation program can accurately account for incomplete ionization of shallow impurities in semiconductors. The occupancies f_{D} and f_{A} are used to describe the degree of ionization. It is assumed that the shallow impurities are in equilibrium with the local carriers and therefore the occupancy of the shallow impurities can be described by:

$${f}_{D} = \frac{1}{1 + {g}_{d}^{- 1} exp [ ( {E}_{D} - {E}_{fn} ) / kT ]} , \\ {f}_{A} = \frac{1}{1 + {g}_{a} exp [ ( {E}_{A} - {E}_{fp} ) / kT ]} , \qquad ( 17 )$$

where the subscripts D and A are used to denote shallow donors and acceptors, respectively.

Based on the discussions above, the occupancy of a deep level trap can be determined through the trap dynamic equation, Equation (10). In general the deep trap is not in equilibrium with the carriers, i.e., the trap does not share the same quasi-Fermi level as the carriers.

From Equations (9) and (10), one obtains the following expression for the trap occupancy under steady state conditions:

$${f}_{tj} = \frac{{c}_{nj} n + {c}_{pj} {p}_{1 j}}{{c}_{nj} ( n + {n}_{1 j} ) + {c}_{pj} ( p + {p}_{1 j} )} . \qquad ( 18 )$$

In the case of surface states or surface recombination centers, the method allows for distribution of dense traps near the surface region, which provides a mechanism for the surface charge states as well as for surface recombination. Fermi level pinning effects on a semiconductor surface can be modeled using this approach.

In a transient simulation the trap occupancy is a function of time, depending on the trap capture rates as well as on the local carrier concentrations. The program uses Equation (10) to determine the trap states at each transient time step.

By default the simulation software may assume incomplete ionization of dopants with energy level defined by the level parameter in the doping statement. The dopants of a specific material may be forced to be fully ionized with the command full ionization. For a more accurate model of incomplete ionization in heavily-doped semiconductors, the Mott transition model can also be used.

The Poole-Frenkel effect (also Frenkel-Poole effect or field induced emission) may be used to describe field dependent thermionic emission from traps in the bulk of an insulator. This mechanism is, however, equally applicable to incomplete ionization of impurities in semiconductors.

Under an electric field F, the electrostatic potential near an impurity center is modified and the effective work function or the ionization energy is reduced by:

$$Δ {E}_{PF} = \sqrt{\frac{qF}{π {∈}_{0} ∈}} . \qquad ( 19 )$$

The Poole-Frenkel model may be implemented by shifting the ionization energy by ΔE_{PF}.

The field dependence of this shift introduces some complication into the discretized Poisson's equation. The reason is that at each node, additional work must be done to search for the maximum field component surrounding the node.

Another complication associated with the Poole-Frenkel model occurs at the ohmic contacts, because the simulator solver is set up such that the built-in potential at an ohmic contact is always fixed, or in other words, the dopant energy level or the Imref at the contact is fixed relative to the band edges. Such an assumption contradicts with the Poole-Frenkel model which changes the ionization energy and the Imrefs as the applied field is varied.

To overcome this difficulty, the ionization energy at the contact is allowed to be shifted to a constant value before the simulation. Without such a shift in the ionization energy at the contact, the ohmic contact may behave like a Schottky contact because of a large fixed built-in potential.

The Poole-Frenkel model is important when the ionization energy is large and the temperature is low (e.g., 100 meV at 100K). Without such a model, the semiconductor may have an unrealistic high resistance.

The carrier mobilities μₙ and μₚ account for the scattering mechanism in electrical transport.

One of the main effects on the mobility is the local electrical field. The software may provide several analytical formulas of field dependent mobility:

The simplest mobility model uses constant mobilities μ₀ₙ and μ₀ₚ for electrons and holes, respectively, throughout each material region in the device.

Another simplified field dependent mobility model is the two-piece mobility model:

μₙ=μ₀ₙ, for F<F₀ₙ;

μₙ=υₛₙ/F, for F≧F₀ₙ;

υₛₙ=μ₀ₙF₀ₙ, (20)

for the electron mobility. F₀ₙ is a threshold field beyond which the electron velocity saturates to a constant. Similar expressions can be defined for holes:

μₚ=μ₀ₚ, for F<F₀ₚ;

μₚ=μ₀ₚF₀ₚ/F, for F≧F₀ₚ;

υₛₚ=μ₀ₚF₀ₚ. (21)

A commonly used mobility model has the following form for electrons and holes, respectively:

$${μ}_{n} = \frac{{μ}_{0 n}}{{( 1 + {( {μ}_{0 n} F / {v}_{sn} )}^{{β}_{n}} )}^{1 / {β}_{n}}} , \\ {μ}_{p} = \frac{{μ}_{0 p}}{{( 1 + {( {μ}_{0 p} F / {v}_{sp} )}^{{β}_{p}} )}^{1 / {β}_{p}}} . \qquad ( 22 )$$

Many III-V compound semiconductors (e.g., GaAs) exhibit negative differential resistance due to the transition of carriers into band valleys with lower mobility. The software may implement the following field-dependent model:

$${μ}_{n} = \frac{{μ}_{0 n} + ( {v}_{sn} / {F}_{0 n} ) {( F / {F}_{0 n} )}^{3}}{1 + {( F / {F}_{0 n} )}^{4}} . \qquad ( 23 )$$

Poole-Frenkel type of field enhanced mobility model. Highly localized carriers with small mobility can be excited by external field to make hopping movements. Commonly used for organic semiconductors, the following mobility model may also be implemented:

μ=μ₀exp[(F/Fₑᵣ)^{px}] (24)

Besides the field dependence of the mobility, another important effect is the impurity dependence of the low field mobility. The program may use the following formulas:

$${μ}_{0 n} = {μ}_{1 n} + \frac{( {μ}_{2 n} - {μ}_{1 n} )}{1 + {( \frac{{N}_{D} + {N}_{A} + {\sum }_{j} {N}_{tj}}{{N}_{rn}} )}^{{α}_{n}}} , \\ {μ}_{0 p} = {μ}_{1 p} + \frac{( {μ}_{2 p } - {μ}_{1 p} )}{1 + {( \frac{{N}_{D} + {N}_{A} + {\sum }_{j} {N}_{tj}}{{N}_{rp}} )}^{{α}_{p}}} , \qquad ( 25 )$$

where values of μ₁, μ₂, Nᵣ and α come from experimental data. Some of these values may also be temperature-dependent.

In many applications, the mobility is anisotropic and also depends on the vertical field. A number of vertical field dependent model (such as the Lombardi model) may also be implemented.

The variety of boundary conditions which may be used for the electrical part, Equations (1) to (3), include ohmic contacts, Schottky contacts, Neumann (reflective) boundaries, lumped elements and current controlled contacts. For the hot carrier equations, the boundary condition may be the contact carrier temperature. The Schottky boundary conditions are often used for electrical contacts. However, the ohmic boundary conditions may be a good approximation when a high doping concentration is present in contact layers. Current boundary conditions are an indirect way of applying voltage boundary conditions. Lumped elements may include external circuit elements such as a resistor or capacitance between the point where the voltage is measured experimentally and the actual device boundary in the model. This can be as simple as a piece of wire or to include the effects of a non-ideal contact pad. The other boundary conditions are for the air/semiconductor interface where no current is allowed to flow across the boundary.

Ohmic contacts are implemented as simple Dirichlet boundary conditions, where the surface potential and electron and hole quasi-Fermi levels (Vₛ, E_{fn}^{s}, E_{fp}^{s}) are fixed. The minority and majority carrier quasi-Fermi potentials are equal and set to the applied bias of the electrode:

φₙ^{s}=φₚ^{s}=−E_{fn}^{s}=−E_{fp}^{s}=V_{applied}. (26)

The potential Vₛ at the boundary is fixed at a value consistent with zero space charge:

$$- n + p + {N}_{D} ( 1 - {f}_{D} ) - {N}_{A} {f}_{A} + {\sum }_{j} {N}_{tj} ( {δ}_{j} - {f}_{tj} ) = 0. \qquad ( 27 )$$

With the solution of Vₛ and Equation (26) one can use Equations (14) to calculate nₛ and pₛ.

The purpose of creating an Ohmic contact in a simulation is to have a boundary condition which does not disturb the area of simulation but provides a path for current flow, in contrast to the Schottky contact which can be either injecting or depleting carriers, depending on the polarity of the bias.

For simulation of a variety of devices, the ideal Ohmic contact with a charge neutral assumption may be sufficient as a good carrier injector if the contact area is highly doped or if the carrier injection requirement is not too high. If the vicinity of the contact has low doping or if a high level of carrier injection is required, the ideal Ohmic contact described above ceases to be a valid model for a realistic Ohmic metal contact. In such a case, it is impossible to simulate injection of carriers into the device, no matter how large the bias current is.

To remedy this problem, a high doping may be used in the vicinity of an ideal Ohmic contact region. Otherwise, a low barrier Schottky contact may also be used.

Schottky contacts to the semiconductor are defined by the barrier height of the electrode metal and a surface recombination velocity. The surface potential at a Schottky contact is defined by:

Vₛ=χ−χ_{ref}−φ_{b}+V_{applied}. (28)

where χ and χ_{ref} are the electron affinities of the semiconductor and a reference material, respectively, and φ_{b} is the Schottky barrier height.

Note that this applies only for n-contacts. For p-contacts, this equation needs to be modified by the semiconductor bandgap to calculate the proper hole barrier. The sum of the barrier heights for electron and holes is expected to be equal to the bandgap.

In general, the quasi-Fermi levels E_{fn}^{s} and E_{fp}^{s} are no longer equal to V_{applied} and are defined by a current boundary condition at the surface instead:

Jₛₙ=γₙ υ̅ₙ^{therm}(nₛ−n_{eq}),

Jₛₚ=γₚ Υ̅ₚ^{therm}(pₛ−p_{eq}), (29)

where Jₛₙ and Jₛₚ are the electron and hole currents at the contact, nₛ and pₛ are the actual surface electron and hole concentrations, and n_{eq} and p_{eg} are the equilibrium electron and hole concentrations if infinite surface recombination velocities are assumed (i.e. φₙ=φₚ=V_{applied}).

The thermal recombination velocities are given by:

$${\overline{v}}_{n}^{therm} = \sqrt{\frac{kT}{2 {m}_{n} π}} , \\ {\overline{v}}_{p}^{therm} = \sqrt{\frac{kT}{2 {m}_{p} π}} , \qquad ( 30 )$$

The constants γₙ and γₚ provide a mechanism to include any correction (e.g. due to tunneling) to the standard theory.

For current transport across an abrupt heterojunction, the thermionic emission model may be used; the expression for the current flux across the junction can be defined as:

Jₕₙ=γₕₙ υ̅_{bn}^{therm}(n_{b}−n_{b0}),

Jₕₚ=γₕₚ υ̅_{bp}^{therm}(p_{b}−p_{b0}), (31)

where n_{b} and p_{b} denote the electron and hole concentrations, respectively, on the barrier side of the junction; n_{b0} and p_{b0} are the corresponding concentrations when the quasi-Fermi levels are the same as those on the opposite side. These equations ensure that, when the quasi-Fermi levels on both sides of the barriers are the same, the net current is zero.

The thermal recombination velocities are given by:

$${\overline{u}}_{bn}^{therm} = \sqrt{\frac{k T}{2 {m}_{bn} π}} , \\ {\overline{u}}_{bp}^{therm} = \sqrt{\frac{k T}{2 {m}_{bp} π}} . \qquad ( 32 )$$

The abrupt heterojunction model allows to accurately describe the thermionic emission behavior (e.g. temperature dependence) of a device using an abrupt heterojunction as a means of carrier confinement.

The abrupt junction model has its limitations, however, especially when both sides of the junction are heavily doped with the same type of dopant (e.g. donors). In such a case, the Fermi level is strongly pinned at the band edges on both sides, and the potential barrier is forced to form a sharp peak above the Fermi level. Since the peak region in the barrier is strongly depleted of carriers, the resistance is very high according to Equation (7). If this junction happens to be reverse biased (i.e. the carriers on the barrier side tend to be more depleted when the bias is applied), the high resistance can cause an unrealistically large voltage drop there.

Fortunately, the difficulty associated with a highly doped abrupt heterojunction does not occur very often near the active regions, because junctions there are rarely heavily doped with the same dopant on both sides. If the heavily doped contact region has an abrupt heterojunction, problems may arise. An example of this is GaAs/AlGaAs, which may have a heavily doped GaAs substrate under the heavily doped cladding region.

In most cases the abrupt junction model is adequate. In setting up a new device structure one may ignore the problem mentioned above unless the simulation result shows an unrealistically large voltage drop. The user may be able to identify such a problem at run-time, e.g. from simulator's run-time printout. For example, if the printout shows that 10 Volts are needed to pass a few mA of current, it usually indicates there is a barrier of some kind

By plotting the band diagram, it should be possible to identify if an abrupt junction is causing this problem. If so, the abrupt junction may be replaced with a graded barrier without affecting any active regions. Usually a graded barrier with grading length of 100 Å or so is adequate to replace the heavily doped junction that is causing the trouble.

Along the outer non-contacted edges of simulated devices, homogeneous reflecting Neumann boundary conditions may be imposed so that current only flows out of the device through the contacts. Additionally, in the absence of surface charge along such edges, the normal electric field component goes to zero. In a similar fashion, current is not permitted to flow from the semiconductor into an insulating region; further, at the interface between two different materials, the difference between the normal components of the respective electric displacements must be equal to any surface charge present along the interface.

Lumped elements have been created to cut down the number of grid points to discretize some device structures, thereby saving CPU time. Lumped resistance might be useful in a simulation of a semiconductor device structure with a substrate contact located far away from the active region. If the whole structure were to be simulated, a tremendous number of grid points, probably more than half, would be wasted to account for a purely resistive region of the device. Because CPU time is generally a superlinear function of the number of grid points, including such regions can be quite expensive.

Applying this boundary condition creates an extra unknown (Vₛ), the voltage on the semiconductor contact, which if defined by Kirchoff s equation:

$$\frac{{V}_{applied} - {V}_{s}}{{R}_{s}} - {\sum }_{i = 1}^{{N}_{b}} ( {J}_{n} + {J}_{P} ) = 0 , \qquad ( 33 )$$

where N_{b} is the number of boundary grid points associated with the electrode of interest.

This auxiliary equation, due to the currents inside the summation, has dependencies on the values of potential and carrier concentrations at the nodes on the electrode as well as all nodes directly adjacent to the electrode. The lumped element contact will have a single voltage (or potential-adjusted for possible doping non-uniformity) associated with the entire electrode.

In the case of substrate resistance of a semiconductor device, one could simulate the n-substrate with ohmic contacts at both ends. From the plot of the contact current versus voltage, the resistance can be directly extracted from the slope.

The current boundary condition may be used, for example, when a laser diode is biased beyond threshold, and the gain and carrier concentration essentially saturate. This also causes the bias voltage to saturate, while the current continues to rise because of stimulated emission.

In some devices (not necessarily lasers), the terminal current is a multi-valued function of the applied voltage. This condition implies that for some voltage boundary conditions, a numerical procedure may end up, depending on the initial approximation solution, with a solution in either of two distinct and stable states. Furthermore, a condition of primary interest is at the trigger point, where dV_{applied}/dI=0, which is difficult to obtain with a simple voltage boundary condition. Additionally, it is nearly impossible to compute any solutions in the negative resistance regime with voltage inputs.

A possible alternative to the difficult situation mentioned above would be to define a current controlled boundary condition, since voltage can be thought of as a single-valued function of the terminal current. Such a boundary condition may be implemented in the software, as an auxiliary equation with an additional unknown boundary potential. Like the lumped element case, a Kirchoff equation is written at the contact points:

$${J}_{source} - {\sum }_{i = 1}^{{N}_{b}} ( {J}_{n} + {J}_{p} ) = 0. \qquad ( 34 )$$

Note that unlike the lumped element case, J_{source} is a constant specified by the user and has no dependence on the boundary potential Vₛ (the Vₛ dependence is buried in the summation). Since the full Newton's method is used for the solution of all equations in the program, no degradation of convergence has been observed for current controlled simulations.

The choice of a voltage or current bias mostly depends on the slope of the current-voltage curve dI/dV_{applied}.

For regions where dI/dV_{applied} is small, the voltage boundary condition is definitely preferable; this occurs frequently below the turn-on voltage or under reverse bias conditions. If the opposite is true, then the current bias is preferable.

It is not uncommon for the negative resistance regime of certain devices to have a slope dI/dV_{applied} very close to zero. Such behavior should be considered when using a current source to trace out an entire current-voltage curve. It might be preferable to switch back to a voltage source after passing the trigger point.

A pure resistor region may be approximated as a special kind of semiconductor. The following material properties may be assigned to represent a metal or resistor region: the bandgap is 0.1 eV, the electron and hole relative effective masses are 10, and the material is undoped.

Due to the heavy mass and small bandgap, the material parameters shown above always pin the Fermi levels at the mid-gap. Pinning the Fermi level means the level is always unchanged. Normally the bias would affect this level but here other effects are stronger so the bias is too weak to affect the Fermi level. Fermi level pinning is often caused by defects/surface states but it is also a feature of metals because of their very high density of states. The pinning results in that equally large amounts of electrons and holes are available for conduction purposes such semiconductors behave exactly like a metal. The mobility parameter can be computed from the conductivity of the metal. Depending on the band alignment with a real semiconductor, the metal macro is capable of injecting electrons and/or holes.

With such a definition, the work function of a real metal is approximately equal to the affinity of the small bandgap metal macro. The difference is only 0.05 eV, negligible for many practical purposes. The work function of a real metal is related to the affinity of metal macro by the following formula:

real_metal_work_function=metal_macro_affinity+0.05 (eV).

Such an approach of treating a real metal as a special-type semiconductor has the advantage of extending the sophisticated semiconductor models, such as AC analysis and quantum tunneling to metals.

The tunneling current may be calculated using the same quantum mechanical propagation matrix approach as in any other tunneling problem. However, the tunneling probability is a function of the conductivity of the metal; i.e. we use the conduction mass of the carriers, a measure of “how fast” the carriers can travel. Earlier, we mentioned pinning of the Fermi level by using very large carrier masses: this is a measure of “how many” carriers there are in the conduction or valence band. This is called the DOS mass (density of states). The DOS mass used to pin the Fermi level (10.0) is much larger than the conduction mass (depends on the material but 0.05 would not be unusual for electrons).

The software may have a command which controls the ratio of the DOS mass to conduction mass and defines the ratio of conduction mass over DOS mass. It may be used to define conduction mass of the metal for tunneling. For example, if the real metal has a relative effective mass of 0.5 while the default DOS mass for a metal macro is 10, a value of 0.05 may be used for in above command.

It is observed experimentally that the shrinkage of bandgap occurs when impurity concentration is particularly high, e.g. nᵢₘₚ>10²³ m⁻³. This effect is so called bandgap narrowing effect which is ascribed to the emerging of the impurity band formed by the overlapped impurity states. The bandgap narrowing model proposed by Slotboom is given by

$$Δ {E}_{g} = {E}_{ref} \{ ln \frac{{n}_{imp}}{{n}_{ref}} + \sqrt{{ln}^{2} \frac{{n}_{imp}}{{n}_{ref}} + 0.5} \} \qquad ( 35 )$$

where E_{ref}, n_{ref} and nᵢₘₚ represent energy parameter, density parameter and impurity concentration, respectively.

In case of silicon, E_{ref} and n_{ref} were obtained by fitting experiment, which yields

E_{ref}=0.009 [V] (36)

n_{ref}=1023 [m²³] (37)

It should be noted that the bandgap narrowing effect is a doping dependent effect, whereas the many body effect, which reduces band gap as well, is carrier dependent effect. A deep level trap located with the semiconductor bandgap is described by both the charge property (deep donor or deep acceptor) as it appears in Poisson's equation and by a rate equation with capture and escape terms:

Rₙ^{tj}=cₙⱼnNₜⱼ(1−fₜⱼ)−cₙⱼn₁ⱼNₜⱼfₜⱼ,

Rₚ^{tj}=cₚⱼpNₜⱼfₜⱼ−cₚⱼp₁ⱼNₜⱼ(1−fₜⱼ). (38)

The simulation software can simulate the behavior of any number of trap levels within the bandgap. In the extreme of densely populated traps such as those appearing in amorphous materials, it is more convenient to use a continuous function to describe the energy distribution of the trap levels, such as the Gaussian and exponential trap distribution. The continuous trap models are defined by parameters within the doping statement.

When the photon energy of light is less than the semiconductor bandgap, it is still possible to generate photo-carriers if deep level traps are sensitive to light. Electrons and holes being trapped in the deep level trap centers require less than bandgap energy to be excited to the conduction or valence bands. We shall also refer to such a process as trap photo-excitation.

In such a case, the Schokley-Read-Hall recombination terms of the drift-diffusion must be revised to include photo-carrier generation terms due to emission from traps (Gₜₙ and Gₜₚ):

Rₙ^{tj}=cₙⱼnNₜⱼ(1−fₜⱼ)−cₙⱼn₁ⱼNₜⱼfₜⱼ−Gₜₙ,

Rₚ^{tj}=cₚⱼpNₜⱼfₜⱼ−cₚⱼp₁ⱼNₜⱼ(1−fₜⱼ)−Gₜₚ. (40)

We will derive the generation term Gtn from the consideration that it must be proportional to trap density and electron occupancy. It must also be proportional to light intensity. Let us recall the photon generation term of direct electron-hole pairs:

Gₑₕ=v_{g}Sα (41)

where v_{g} is the group velocity of light, S the photon density, and α the absorption coefficient.

In analogy, we can write down the trap excitation term as:

Gₜₙ=υ_{g}SNₜⱼfₜⱼσₓₙ (42)

where σₓₙ has the unit of area and we shall refer to it as trap photo-excitation cross section; this cross section times the amount of trapped electrons (i.e., Nₜⱼfₜⱼ) may be compared with usual bulk material absorption coefficient in units of 1/m.

Similarly, trap excitation for holes is given by:

Gₜₚ=v_{g}SNₜⱼ(1−fₜⱼ)σₓₚ (43)

The numerical technique used by the method described with reference to FIG. 1 will be discussed in more detail; it relates to solving the drift-diffusion equations on a discretized 2 or 3 dimensional finite element mesh. The 3D mesh may be regarded as a collection of 2D planes with carefully constructed plane-to-plane finite element connectivity. The reduction of 3D into 2D in case of cylindrical symmetry is also discussed.

Equations (1) to (3) describe the electrical behavior of the bulk or quantum well semiconductor devices. Poisson's equation (Equation 1) governs the electrostatic potential and the continuity equations (2) and (3) govern the carrier concentrations.

These differential equations are discretized as described later. The resulting set of equations is coupled and nonlinear. Consequently, there is no method to solve the equations in one direct step. Instead, solutions must be obtained by a nonlinear iteration method, starting from some initial approximation.

To be solved on a computer, the device equations must be discretized on a simulation grid; i.e. the continuous functions of the PDE's are represented by vectors of function values at the nodes, and the differential operators are replaced by suitable difference operators. Instead of solving for four unknown functions (potential, electron and hole concentrations, and the electron or hole energy), the simulator solves for 3N or 4N unknown numbers, depending on the model choice, where N is the number of grid points.

The key to discretizing the differential operators on a general triangular grid is the box method. Each equation is integrated over a small polygon enclosing each node, yielding 4N nonlinear algebraic equations for the unknown potential, concentrations and the wave amplitude. The integration equates the flux into the polygon with the sources and sinks inside it, so that conservations of current and electric flux are built into the solution.

The integrals involved are performed on a triangle by triangle basis, leading to a simple and elegant way of handling general surfaces and boundary conditions. In this case the integral is simply replaced by a summation of the integrand evaluated at the node multiplied by the area surrounding it.

For the hydrodynamic model, the SG-formula for discretization is preferably modified.

The Newton's method may be applied to the numerical solution of drift-diffusion equations. In Newton's method, all of the variables in the problem are allowed to change during each iteration, and all of the coupling between variables is taken into account. As a result, the Newton algorithm is very stable, and the solution time is nearly independent of bias conditions.

The basic algorithm is a generalization of the Newton-Raphson method for the root of a single equation. Equations (1)-(3) can be written as:

Fᵥ^{j}(V^{j1},E_{fn}^{j1},E_{fp}¹)=0,

Fₙ^{j}(V^{j1},E_{fn}^{f1},E_{fp}^{j1})=0

Fₚ^{j}(V^{j1},E_{fn}^{j1},E_{fp}^{j1})=0, (44)

where j runs from 1 to N, and j₁ includes j itself plus its surrounding mesh points. Equations (44) represent a total number of 3N equations, which is sufficient to solve for 3N variables: (V¹, E_{fn}¹, E_{fp}¹, V², E_{fn}², E_{fp}², . . . , V^{N}, E_{fn}^{N}, E_{fp}^{N}).

Once the equations are discretized in the above form, the standard Newton techniques can be used. These involve the evaluation of the Jacobian matrix to linearize Equations (44), followed by a linear solver (involving LU factorization of the matrix) and finally, nonlinear iteration to get the final solution. Since the Jacobian matrix is sparse, sparse matrix techniques are used to improve the computation speed.

The major acceleration of a Newton iteration is the Newton-Richardson method, whereby the Jacobian matrix is only refactored when necessary. When it is not necessary to factorize, the iterative method using the previous factorization is employed. The iterative method is extremely fast provided the previous factorization is reasonable. Frequently the Jacobian need only be factorized only once or twice per bias point using the Newton-Richardson method, as opposed to the twenty to thirty times required in the conventional Newton method. The decision to refactor is made on the basis of the decrease per step of the maximum error of both the equation residuals and the variable differences.

Several types of initial approximation solutions may be used. The first is the simple charge neutral assumption used to obtain a model at the first (equilibrium) bias point.

For the wave equation, the initial approximation solution is a delta function at the center of the active region. This may be a starting point of any device simulation.

Any later solution with applied bias needs an initial approximation of some type, obtained by modifying one or more previous solution(s). When only one previous solution is available, the solution currently loaded is used as the initial approximation, modified by setting the applied bias at the contact points. The same is true for the wave equation. When two previous solutions with two different biases are available, it is possible to obtain a better initial approximation by extrapolating the two previous solutions.

As in any Newton method, the convergence strongly depends on the choice of the initial approximation solution. In principle, the Newton nonlinear iteration should always converge as long as the initial approximation is close enough to the solution. The closer the initial approximation is to the solution, the fewer nonlinear iterations are required to reach convergence. The program may implement an adaptive method to control the bias step after the successful convergence of the previous solution.

Assuming that the previous solution took K₁ number of iterations for a bias step of ΔV₁ to reach convergence, and that the optimal number of iterations should be K₀, the current bias step ΔV₂ is adjusted to ΔV₂=ΔV₁K₀/K₁. In this way an optimal step can be determined such that the nonlinear Newton iteration is controlled to converge within K₀ iterations. This procedure may be performed automatically by the software.

One common cause of convergence problems in a Newton method is oscillations in the solution. This usually occurs when the initial approximation is poor and the solver overshoots the solution. In order to prevent this, a damping value may be implemented so as to prevent the solver from changing the solution too much between successive iterations. A small damping value will damp the oscillations effectively but may cause slower convergence. A large value allows faster convergence when the initial approximation is poor but carries a larger risk of oscillations.

The backward Euler method may be used to discretize the differential equations in time. Its basic approximation is the following equation:

$$\frac{\partial S}{\partial t} = \frac{S ( t ) - S ( t - Δ t )}{Δ t} . \qquad ( 45 )$$

This method has the advantages of being highly stable and recovers the steady state solution in the limit Δt→∞.

Strictly speaking, the simulation system has more than 5 sets of equations when the trap dynamic equation (10) is also included in a transient simulation. However, this equation is only dependent on local variables and can be solved before the major Newton step involving all mesh points.

Once all the equations are discretized in terms of solution of the previous time step, the solution at the present time step may be obtained using the same method as for the steady state solution, i.e. one can linearize the discretized equations and use Newton's method to solve them.

Correct allocation of the grid is a crucial issue in device simulation. The number of nodes in the grid (N) has a direct influence on the simulation time, where the number of arithmetic operations necessary to achieve a solution is proportional to N^{p} where p usually varies between 1.5 and 2.

Because different parts of a device have very different electrical and optical behavior, it is usually necessary to allocate a fine grid to some regions and a coarse grid to others. Whenever possible, it is desirable not to allow the fine grid in some regions to spill into regions where it is unnecessary, in order to maintain a reasonable simulation time.

The first step in mesh generation is to specify the device boundaries and the region boundaries for each material. The program uses triangles and trapezoids as the basic building blocks to describe an arbitrary device. Furthermore, the edge of each polygon can be bent to the desired shape.

The basic operation in the mesh generator after the boundaries have been defined is to draw lines parallel to the edges of the polygons. This way one obtains, smaller trapezoids which can be bisected into two triangles (the basic elements in the finite element method).

Another basic operation is doubling the mesh density in a specified region. This is accomplished by drawing a new line between the old mesh lines. Repeating this operation, one can manually generate a mesh with any variation of mesh densities.

The simulator has provided another practical approach to automatic mesh generation and refinement. The mesh is refined according to the variation of specified physical quantities. For example, in a case where the potential variation between two adjacent nodes is greater than a value specified by the user, the program will automatically allocate additional mesh points between the two nodes.

Since many devices are fabricated with cylindrical symmetry (e.g. VCSELs, photodetectors), it is a good idea to establish a cylindrical coordinate system for device simulation. By making use of the rotational symmetry, we can reduce the three-dimensional coordinate system to a two-dimensional one. To do so, we first consider our differential equation systems under a general coordinate system. Then, we apply the theory to the cylindrical system.

In order to re-write the drift-diffusion equation, usually written in Cartesian coordinates, (x,y,z), in the new coordinate system (q₁, q₂, q₃) which are orthogonal to each other. We start by considering a small distance along each of the three coordinates:

$${ds}_{j} = {H}_{j} {dq}_{j} , {H}_{j} = \sqrt{{( \frac{\partial x}{\partial {q}_{1}} )}^{2} + {( \frac{\partial y}{\partial {q}_{2}} )}^{2} + {( \frac{\partial z}{\partial {q}_{3}} )}^{2}} . \qquad ( 46 )$$

Then the gradient of a scalar variable u is given by:

$$∇ u = \frac{1}{{H}_{1}} \frac{\partial u}{\partial {q}_{1}} {e}_{1} + \frac{1}{{H}_{2}} \frac{\partial u}{\partial {q}_{2}} {e}_{2} + \frac{1}{{H}_{3}} \frac{\partial u}{\partial {q}_{3}} {e}_{3} \qquad ( 47 )$$

where eⱼ is used to denote the unit vector for each of the new coordinates.

Let us derive the expression for the divergence, ∇·A of an arbitrary vector A. We consider a small volume defined within from q₁ to q₁+dq₁, q₂ to q₂+dq₂, and q₃ to q₃+dq₃. The outgoing flux (A) though the surfaces at q₁ and q₁+dq₁ of this small volume is given by:

$$( {A}_{1} {H}_{2} {H}_{3} ) {{\vert}_{q 1 + dq 1} {dq}_{2} {dq}_{3} - ( {A}_{1} {H}_{2} {H}_{3} ) \vert}_{q 1} {dq}_{2} {dq}_{3} = \frac{\partial }{\partial {q}_{1}} ( {A}_{1} {H}_{2} {H}_{3} ) {dq}_{1} {dq}_{2} {dq}_{3} \qquad ( 48 )$$

Similarly, the flux through surfaces at q₂ and q₂+dq₂ is given by:

$$\frac{\partial }{\partial {q}_{2}} ( {A}_{2} {H}_{3} {H}_{1} ) {dq}_{1} {dq}_{2} {dq}_{3} \qquad ( 49 )$$

and the flux through surfaces at q₃ and q₃+dq₃ is given by:

$$\frac{\partial }{\partial {q}_{3}} ( {A}_{3} {H}_{1} {H}_{2} ) {dq}_{1} {dq}_{2} {dq}_{3} \qquad ( 50 )$$

The divergence is defined as the total outgoing flux divided by the volume under consideration:

$$∇ \cdot A = \frac{1}{{H}_{1} {H}_{2} {H}_{3}} [ \frac{\partial }{\partial {q}_{1}} ( {H}_{2} {H}_{3} {A}_{1} ) + \frac{\partial }{\partial {q}_{2}} ( {H}_{3} {H}_{1} {A}_{2} ) + \frac{\partial }{\partial {q}_{3}} ( {H}_{1} {H}_{2} {A}_{3} ) ] \qquad ( 51 )$$

The relation between the old (x₁,y₁,z₁) and the new coordinate system (r,θ,zᵣ) is given by:

x₁=r cos θ

y₁=r sin θ

z₁=zᵣ (52)

To avoid confusion with the (x,y,z) system used in our simulation software, we have used a new set of symbols here. In our simulator, x,y are the lateral and vertical coordinates of a 2D plane and z is a depth coordinate used to stack planes. In the cylindrical system, the zᵣ axis is usually normal to the layers and corresponds to y so that r corresponds to x.

It is easy to find that:

Hᵣ=1,H_{θ}=r,H_{z}=1.

Therefore, the gradient is given by:

$$∇ u = \frac{\partial u}{\partial r} {e}_{r} + \frac{1}{r} \frac{\partial u}{\partial θ} {e}_{θ} + \frac{\partial u}{\partial {z}_{r}} {e}_{z}$$

and the divergence is given by:

$$∇ \cdot A = \frac{1}{r} [ \frac{\partial }{\partial r} ( r {A}_{r} ) + \frac{\partial }{\partial θ} ( {A}_{θ} ) + \frac{\partial }{\partial {z}_{r}} ( {rA}_{z} ) ] \\ or \\ ∇ \cdot A = \frac{1}{r} \frac{\partial }{\partial r} ( r {A}_{r} ) + \frac{1}{r} \frac{\partial }{\partial θ} {A}_{θ} + \frac{\partial }{\partial {z}_{r}} {A}_{z} \qquad ( 53 )$$

For device with cylindrical symmetry,

$$\frac{\partial }{\partial θ}$$

yields zero. The operators of gradient and divergence become:

$$∇ u = \frac{\partial u}{\partial r} {e}_{r} + \frac{\partial u}{\partial {z}_{r}} {e}_{z} \\ ∇ \cdot A = \frac{1}{r} [ \frac{\partial }{\partial r} ( r {A}_{r} ) + \frac{\partial }{\partial {z}_{r}} ( {rA}_{z} ) ] \qquad ( 54 )$$

Therefore it is easy to see that in the cylindrical system, all we need to do is to replace A by rA and multiply 1/r in front of the differential operators.

Our next task is to convert the new differential equation into a suitable discretization scheme for the cylindrical system. Let us recall how we discretize the drift-diffusion equation in the old coordinate system. We evaluate the gradient (the electric field or the current density vector) for each boundary of the finite box which we create for the neighboring elements. We then sum up the total flux and divide it by the area of the finite box. In the new system, we need to multiply the flux by r which is evaluated at the boundary point. We also divide the total flux by the area of the finite box and by r evaluated at the center of the box (or the center point).

The missing dimension is no longer infinite but has rotational symmetry. For example, we need to integrate current density over the 2π radians to get the total current.

For the three-dimensional mesh generation, we find the parallel cross sections of a device that has the most variation in physical variables and define them as x,y planes. Within these planes, we use the same 2D mesh generation routines as before. The z direction will have a relatively slower variation and can be sparsely meshed to reduce the overall number of mesh points: every z mesh point will be accompanied by a 2D mesh plane.

For example, a ridge waveguide laser would use the waveguide cross-section as the x,y direction and the z axis would be the longitudinal propagation axis. On the other hand, an LED with complex electrode shapes would define the x,y planes to be parallel to the electrodes and the z axis would be perpendicular to the QW layers. In a cylindrical system, 3D simulations imply a lack of rotational symmetry and the x,y (or r,zr) planes would stack together in the θ direction.

The next step of the input is to define regions that have the same material properties and composition. These are called “segment” or “z-segment” and are defined by the z structure statement. A segment can have multiple mesh planes: these will share the same material properties such as bandgap and doping but variables such as potential and carrier concentrations are allowed to change between planes.

To define a 3D volume, at least 2 mesh planes must be defined. However, at least 3 mesh planes must be present to get a variation along the z-axis. Segments containing a single mesh plane are allowed but must have zero thickness: additional planes and segments will be needed to define a 3D volume.

After all the z structure statements have been issued, multiple load mesh statements must be issued and associated with segments. After the mesh has been loaded, the material properties for each segments must be defined.

Material properties that need be defined in this way include: material declarations, active region declarations, doping statements, and contact definitions.

Just as materials can reoccur between segments, so can contacts the same boundary conditions applies everywhere and the electrode current is also summed up for all segments. If each segment is to be biased independently from the other, then different contact numbers must be used. For example, it is possible for a tunable DBR laser to have a shared bottom electrode with split top contacts for the gain, tuning and DBR segments.

However, contacts in each 2D layer file should be numbered according to the final 3D structure and whether or not they will be shared between segments.

As explained above, the three-dimensional mesh consists of a series of two-dimensional mesh planes stacked together. The position of these mesh planes is determined by the length of the segments and the number of planes that have been assigned. This number may be assigned manually by the user, just like the number of mesh points in a column or layer.

When a segment has multiple planes, there will usually be planes at the beginning and end of the segment. If there are multiple segments, this can cause a problem since two mesh planes cannot exist in the same z position.

If there is a heterojunction at a segment boundary, then eliminating the extra plane can have disastrous consequences on convergence. Just like the 2D case, the closely spaced mesh points on either side of the junction are needed to get convergence.

For the other planes inside a segment, their position can be also be controlled via mesh point ratios: the z structure statement supports a feature similar to that of put mesh in the 2D mesh generator.

Every mesh point has a polygon associated with it. To connect mesh points between planes, we extrude this polygon in either direction to the midpoint of the preceding and following mesh plane. This forms prism-like 3D objects that are different from the traditional tetrahedral elements used in 3D FEM.

Flux conservation is consistent with the box method described earlier: connecting mesh points are assigned part of the flux based on the overlap between the two extruded polygons. A projection is used to account for the case where the two mesh planes are not parallel.

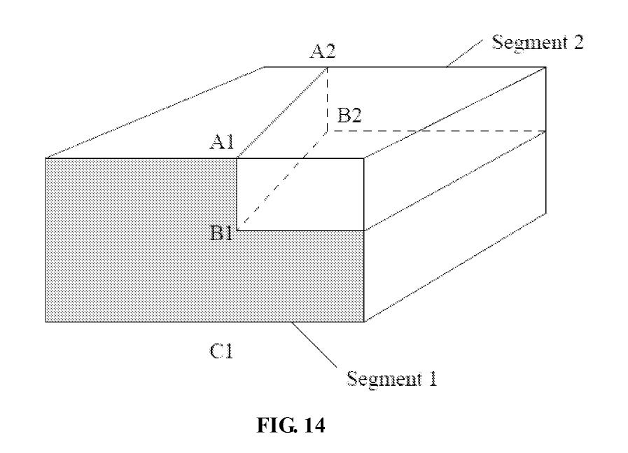

To explain how tapers may be handled in the software, we need to introduce the concept of “taper lines” as illustrated in FIG. 14.

Consider a structure with a taper extending from points A1-B1 on segment 1 to A2-B2 on segment 2. We define a “taper line” A1-C1 on segment 1 and a corresponding taper line A2-C2 (point C2 is hidden behind the figure). These taper lines are used to extend a particular boundary from one plane to the corresponding boundary on the other.

This will divide the mesh on either side of the taper line and force mesh points to connect across planes without crossing the taper lines: this is especially important when dealing with semiconductor/insulator interfaces. As a result, the extrusion process described above no longer follows the z axis: it follows taper lines. To define a taper in .sol, two segments must be defined with the taper points parameters: multiple sets of taper points can be used to define multiple taper lines.

The two segments must not overlap and the taper region will extend in the empty space between the last plane of the first segment and the first plane of the second segment.

Note that a very common misconception is that material properties in tapers are linearly interpolated between planes: for the electrical calculations, this is completely untrue. Tapers only control the connectivity between mesh planes: actual mesh planes must be assigned at various z positions in order to sample the variation of physical properties.

Once the 3D material data and mesh has been created, a 3D simulation is relatively straightforward. The .sol file works the same as before and bias can still be applied to specified electrodes. When the Newton solver is called, all mesh planes will be solved simultaneously to obtain the 3D solution. The main difference is that 2D simulations use currents in A/m units (since the z depth is not known). A 3D simulation, just like a cylindrical simulation, can compute the full current in Amperes.

For simulations with split contacts between segments, we advise caution when biasing as you may inadvertently create a short between neighboring electrodes in certain situations. This can usually be avoided by biasing multiple electrodes simultaneously.

The simulation results may be provides to the user in the graphical form, or may be stored or passed to another program e.g. for design optimization.

1.-22. (canceled)

23. A method of simulating a semiconductor device in a steady state, comprising:
simulating a displacement current in the semiconductor device, comprising computerized solving a system of equations, wherein the system of equations includes displacement current terms and is discretized using time steps greater than lifetimes of carriers in the semiconductor device, so as to compute solutions of the system of equations at each of the time steps; and,
determining an approximate steady-state model of the semiconductor device to which the solutions converge.

24. The method as defined in claim 23, wherein simulating the displacement current is simulated in dependence upon at least one of: scattering of electrons, carrier energy or carrier temperature distribution, carrier recombination due to deep level traps, thermionic emission, or ionization of dopants.

25. The method as defined in claim 24, wherein the system of equations comprises drift-diffusion equations.

26. The method as defined in claim 25, wherein the system of equations includes steady-state current terms.

27. The method as defined in claim 26, comprising forming an output based on the approximate steady-state model and outputting the output.

28. The method as defined in claim 27, wherein the system of equations is solved for electrostatic potential, electron and hole concentrations, and electron and hole energies.

29. The method as defined in claim 28, wherein the semiconductor device comprises at least one of: a floating gate, an organic semiconductor, an insulator, a semi-insulating semiconductor, a device with a semiconductor region of high resistivity, a device with highly doped reverse p-n junction(s), a wide bandgap semiconductor, an amorphous semiconductor, or a bistable device.

30. The method as defined in claim 26, wherein the system of equations comprises Shockley-Read-Hall equations.

31. The method as defined in claim 25, wherein a convergence criterion is used for determining the approximate steady-state model to which the solutions converge.

32. The method as defined in claim 28, wherein the system of equations is discretized in time based on a backward Euler method.

33. The method as defined in claim 32, wherein the system of equations is discretized in space using a finite element or finite volume mesh.

34. The method as defined in claim 23, further comprising provides a graphical, interactive representation of the semiconductor device.

35. A method of designing a semiconductor device, wherein the semiconductor device is simulated using the method defined in claim 28.

36. A non-transitory computer-readable storage medium configured with instructions for computer simulation of a semiconductor device, wherein the software, when executed by a computer system, causes the computer system to perform the method defined in claim 23.

37. A method of simulation of a wide-bandgap semiconductor device with a bandgap parameter having a wide-bandgap value, comprising:
(a) providing a model of a narrow-bandgap device, wherein the model includes the bandgap parameter having a low-bandgap value, and the low-bandgap value is less than the wide-bandgap value by at least 10% of the wide-bandgap value;
(b) increasing an electric current in the model of the narrow-bandgap device by gradually adding an external bias to the model of the narrow-bandgap device and computing a biased model of the narrow-bandgap device;
(c) modifying the biased model of the narrow-bandgap device so as to change a value of the bandgap parameter to the wide-bandgap value, by gradually increasing the value of the bandgap parameter and computing a biased wide-bandgap model; and,
(d) reducing the external bias in the biased wide-bandgap model so as to gradually change said biased wide-bandgap model by decreasing the external bias and computing a model of the wide-bandgap semiconductor device;
wherein computing the biased model of the narrow-bandgap device, the biased wide-bandgap model, and the model of the wide-bandgap semiconductor device include computerized solving a system of DD equations.

38. The method as defined in claim 37, wherein the external bias is a voltage, reverse voltage, or light.

39. The method as defined in claim 38, wherein the external bias is introduced in a boundary condition of the system of DD equations.

40. A method of computer simulation of a semiconductor device using a device substitution technique, wherein the semiconductor device is described by device parameters having semiconductor-device values; the method comprising:
(a) providing a model of a first device, the model comprising the device parameters,
wherein the device parameters comprise selected parameters and non-selected parameters,
wherein the non-selected parameters of the first device have the semiconductor-device values and
the selected parameters of the first device have first-device values different from the semiconductor-device values for the selected parameters, and
wherein the model of the first device is a solution of a system of equations including the device parameters;
(b) simulating an increase of an electric current in the first device by adding an external bias to the model of the first device, comprising a first series of steps,
wherein, at each step in the first series, a biased model is obtained by computerized solving the system of the equations with an external bias,
wherein at a first step in the first series the computerized solving uses the model of the first device and at each next step in the first series the computerized solving uses the biased model obtained at a previous step in the first series, and
wherein at each next step in the first series the external bias is greater than or equal to the external bias at a previous step in the first series;
(c) correcting the biased model obtained at a last step in the first series, comprising a second series of steps,
at each step in the second series a corrected model is obtained by computerized solving the system of the equations with an external bias,
wherein at a first step in the second series the computerized solving uses the biased model obtained at the last step in the first series and at each next step in the second series the computerized solving uses the corrected model obtained at a previous step in the second series, and
wherein at each next step in the second series the external bias is less than or equal to the external bias at a previous step in the second series;
wherein values of the selected parameters change along the second series of steps so as to reach the semiconductor-device values, and
a last corrected model in the second series is a model of the semiconductor device; and,
(d) forming an output based on the model of the semiconductor device and outputting the output.

41. A non-transitory computer-readable storage medium configured with instructions for computer simulation of a semiconductor device, wherein the software, when executed by a computer system, causes the computer system to perform the method defined in claim 40.
